(19) United States
(12) Patent Application Publication
(10) Pub. No.: US 2026/0238806 A1
(43) Pub. Date: Aug. 13, 2026

(54) WEIGHTED FILTERING FOR PICTURE ENHANCEMENT IN VIDEO CODING

(71) Applicant: GUANGDONG OPPO MOBILE TELECOMMUNICATIONS CORP., LTD., Dongguan (CN)

(72) Inventors: Tim CLASSEN, Dongguan (CN); Mathias WIEN, Dongguan (CN)

(21) Appl. No.: 19/638,044

(22) Filed: Apr. 2, 2026

Related U.S. Application Data
(63) Continuation of application No. PCT/CN2023/123114, filed on Oct. 6, 2023.

(51) Int. Cl. H04N 19/33; H04N 19/105; H04N 19/117; H04N 19/159; H04N 19/80

(52) U.S. Cl. CPC H04N 19/33; H04N 19/105; H04N 19/117; H04N 19/159; H04N 19/80

(57) ABSTRACT

A method of processing video data includes: obtaining a plurality of original pictures from original video data; obtaining a plurality reference pictures; upsampling the plurality of reference pictures to obtain a plurality of upsampled reference pictures; obtaining a weighted filter by: determining a weighting map for each reference picture using a weighting map function, and determining a filter to be applied to the upsampled reference pictures with respective the weighting maps to obtain filtered upsampled reference pictures; performing inter prediction of a plurality of blocks of a first picture based on a plurality of reference blocks from one or more of the upsampled reference pictures; and encoding the video data coding information into a bitstream; applying the weighted filter to the plurality of upsampled reference pictures prior to performing the inter prediction, or applying the weighted filter to upsampled referenced blocks of the reference pictures during the inter prediction.

### CROSS-REFERENCE TO RELATED APPLICATION

The present disclosure is a Continuation Application of PCT/CN2023/123114 filed Oct. 6, 2023, which is incorporated herein by reference in its entirety.

### TECHNICAL FIELD

The present application relates to the field of computer vision, in particular to the topic of video processing and video coding, more particularly to a method, a decoder, an encoder, and a non-transitory computer-readable medium for weighted filtering for picture enhancement in video coding.

### BACKGROUND

Current video coding schemes such as H.265/HEVC (High Efficiency Video Coding) and H.266/VVC (Versatile Video Coding) support spatial scalability of the coded video stream. This support for spatial scalability was included in the second version of HEVC with the scalability extension SHVC while VVC natively supports spatial scalability. Adaptively changing the resolution of the coded video during coding is known from VVC as reference picture resampling (RPR) or adaptive resolution change (ARC). Moreover, multiple-resolution coding and multi-layer coding allows for a scalable resolution of the coded video. For that reason, the spatial resolution at which a video is coded may change adaptively and no longer needs to be equivalent to the output or input resolution of the video. The advantages of this additional flexibility are that coding a lower resolution video requires a lower bitrate and may reduce computational complexity at the cost of losing high frequency information in the downsampling step.

Coding a video at lower resolution than its original resolution requires a downsampling and an upsampling step in the signal processing chain. In the downsampling step, an anti-aliasing filter is applied to prevent artifacts caused by high frequency components in the image. The upsampling process applies interpolation filters to reconstruct the intensity values at fractional sample positions.

In RPR, the resolution of the coded video stream may change adaptively. Consequently, the encoder may code parts of the video stream at lower resolution. RPR is applied in the inter-prediction every time that a picture uses a reference picture of different resolution than the current picture in inter prediction. In this step, a resampling operation needs to be applied such that the referenced picture block is mapped to the same spatial resolution as the current picture.

In multi-layer coding, the video is coded at different resolution layers. In a first step, the video is coded at the lowest resolution layer. To generate the video stream of the next layer, the video is upsampled and, potentially, a residual is coded and further processing steps are applied. This process may be applied multiple times based on the number of layers.

Finding an optimal high-resolution representation from the low-resolution picture is an important part of the above-mentioned coding schemes. One method is to apply a set of multi-phase Finite Impulse Response (FIR)-interpolation filters. While those filters do provide an approximation of the high-resolution image content, they cannot recover information that was lost in the downsampling process and suffer from limitations of the linear filtering operation. Consequently, upsampled images are often blurred.

An image sharpening operation can increase the picture quality. However, linear high-pass filters frequently cause artifacts such as overshoot and ringing. Moreover, the distortions caused by the down- and upsampling depend on the image content and the coding quality of the video (influenced by the Quantization Parameter (QP) value).

Filtering the video in order to increase the quality of the picture requires that there are statistical dependencies that can be exploited by the filtering system. In general, it makes sense to apply in-loop filtering if the quality improvement achieved by the filtering outweighs the signaling costs at this rate distortion (RD)-point. Moreover, the computation time needs to be acceptable.

In a number of video coding systems, a series of filters are applied which address different types of coding errors. For example, there is a de-blocking filter which can applied at block borders to decrease blocking artifacts. Next, there can be a sample adaptive offset (SAO) filter which is mainly designed to reduce ringing or blurring artifacts. Lastly, an adaptive loop filter (ALF) could be used for an objective quality enhancement. Note that this is only a small excerpt and meant as an overview of different applications and types of loop filters.

Most of these filters deal only with a limited range of coding errors. Moreover, there are no filters implemented in VVC/H.266 which explicitly target the problem of blurred picture content. However, blurring does happen, due to the quantization or removal of high-frequency components. Usually, linear filters are insufficient to recover blurred content due to problems of overshoot and ringing. Moreover, noise amplification is a problem. Linear filtering approaches like the adaptive loop filter attempt to deal with that problem by introducing a set of classes for which different filters are applied. However, this increases coding costs.

### SUMMARY

Embodiments of the present application provide a method, a decoder, an encoder, and a non-transitory computer-readable medium.

According to a first aspect, there is provided method of processing video data, performed by an encoder, the method comprising: obtaining a plurality of original pictures from original video data; obtaining a plurality reference pictures, each corresponding to an original picture from the original video data, wherein the plurality of reference pictures are at lower resolutions than the original pictures from the original video data; upsampling the plurality of reference pictures to obtain a plurality of upsampled reference pictures; obtaining a weighted filter to reduce an overall error between the plurality of upsampled reference pictures and the corresponding original pictures, by: determining a weighting map for each reference picture, using a weighting map function, the weighting map comprising a plurality of weights mapped to respective spatial locations of the upsampled reference pictures, wherein the upsampled reference pictures are used as an input to the weighing map function, and determining a filter to be applied to the upsampled reference pictures with the respective weighting maps to obtain filtered upsampled reference pictures, such that the filter is applied with different weights to different spatial locations of the upsampled reference pictures; performing inter prediction of a plurality of blocks of a first picture based on a plurality of reference blocks from one or more of the upsampled reference pictures; and encoding the video data coding information into a bitstream, the coding information comprising information on the weighting map function and/or filter to be used at a decoder, wherein the method further comprises: applying the weighted filter to the plurality of upsampled reference pictures prior to performing the inter prediction, or applying the weighted filter to upsampled referenced blocks of the reference pictures during the inter prediction.

In some embodiments, obtaining the weighted filter to reduce the overall error between the plurality of upsampled reference pictures and the corresponding original pictures comprises: assigning respective importance weighting factors to the plurality of reference pictures and/or to areas of the plurality of reference pictures, and determining the overall error between the plurality of upsampled reference pictures and the corresponding original pictures by weighting the error of each upsampled reference picture based on its importance weighting factor.

In some embodiments, assigning respective importance weighting factors to the plurality of reference pictures comprises: assigning higher importance weighting factors to reference pictures that are temporally closer to the first picture.

In some embodiments, assigning respective importance weighting factors to the plurality of reference pictures comprises: assigning the importance weighting factors based on the quality of each reference picture.

In some embodiments, assigning respective importance weighting factors to the plurality of reference pictures comprises: assigning the importance weighting factors based on local picture features or historical information from encoding the reference pictures or other pictures of the video data.

In some embodiments, the method further comprises: adding the obtained weighted filter to a stored reference filter set.

In some embodiments, assigning respective importance weighting factors to the plurality of reference pictures and/or to areas of the plurality of reference pictures comprises: performing a trial encoding of the first picture; identifying which reference pictures and/or blocks in reference pictures are used in trial encoding for inter prediction of one or more blocks of the first picture; and assigning a high importance weighting factor to the identified reference pictures and/or blocks.

In some embodiments, the coding information comprises signalled weighting map function parameters configured to allow the decoder to obtain the weighting map using the weighting map function by: applying the signalled weighting map function parameters as parameters of the weighting map function; and providing the reference pictures as an input to the weighting map function.

In some embodiments, the coding information comprises signalled filter function parameters configured to allow the decoder to obtain the filter by: applying the signalled filter function parameters as parameters of the filter.

In some embodiments, the weighting map and the filter are configured to be applied to the first picture to obtain the filtered first picture as a step within the coding loop or as a post-loop step.

In some embodiments, the coding loop is a H.266/VVC coding loop.

In some embodiments, the weighting map and the filter are configured to be integrated into an adaptive loop filter and applied to derived partitions of the reference pictures or first picture to obtain the filtered picture.

In some embodiments, the bitstream is rate distortion (RD)-optimized based on an estimated signaling rate and distortion after applying the weighting map and the filter to the reference pictures or first picture.

In some embodiments, the reference pictures and/or first picture comprise a luma-channel, a chroma channel or both, and wherein the weighting map and the filter are configured to be applied to the luma-channel, the chroma channel or both.

In some embodiments, which of the luma-channel and the chroma channel the weighting map and the filter are to be applied to is predetermined, signaled in the coding information, or configured to be inferred from the pictures' content.

In some embodiments, the method further comprises partitioning the reference pictures and first picture into a plurality of partitions, wherein the weighting map and the filter are configured to be applied to one or multiple partitions of the reference pictures or first picture, wherein the partitions are signaled in the coding information.

In some embodiments, the partitions being signaled in the coding information comprises a signaled block-partitioning, signaled region partitioning criteria or a binarized weighting map function in the coding information.

In some embodiments, the method further comprises determining a plurality of filters to be applied to a same picture partition.

In some embodiments, the filter is configured to address the problem of ringing artifacts, blurring and/or blocking artifacts in the picture.

In some embodiments, determining the weighting map using a weighting map function comprises: applying a weighting map function which outputs a scalar weighting map, with the scalar being binary, integer or floating-point.

In some embodiments, determining the weighting map using a weighting map function comprises: applying a weighting map function which outputs a multi-dimensional weighting map, with each element being binary, integer or floating-point.

In some embodiments, the weighting map information for one or more channels of the reference pictures is computed using information from one or more channels of the reference pictures as input.

In some embodiments, a set of weighting map functions are predefined, and the coding information signals the weighting map function to be used.

In some embodiments, the weighting map functions are parametric.

In some embodiments, the coding information signals a plurality of weighting map functions, wherein obtaining the weighting map using the weighting map function comprises determining a plurality of weighting maps using the plurality of weighting map functions, and wherein one or more filters are configured to be applied for each signaled weighted map.

In some embodiments, the filtering function and parameters of the filter are signaled in the coding information, pre-defined, configured to be inferred from the content of the video, or configured to be inferred from the coding information.

In some embodiments, the filter is a linear filter, and a shape of the filter is indicated in the bitstream or predefined.

In some embodiments, the linear filter is optimized by a least-squares optimization or RD-optimized.

In some embodiments, the linear filter is a parametric linear filter.

In some embodiments, the parametric linear filter is RD-optimized with regards to a minimal error at the output, derived by least squares optimization, iterative search, or exhaustive search.

In some embodiments, the filter is a bilateral filter.

In some embodiments, obtaining the filter comprises obtaining a plurality of filters, wherein each filter of the plurality of filters is configured to be applied at a location signaled in the bitstream or indicated in the weighting map.

In some embodiments, a parametric weighting map is optimised together with the filtering function.

In some embodiments, one or more filters are configured to be applied to partitions of the reference pictures or first picture based on a block-partitioning signaled in the coding information.

In some embodiments, one or more filters are configured to be applied to partitions of the reference pictures or first picture based on derived region partitioning criteria.

In some embodiments, the filter and weighting map calculation parameters are encoded by a quantization, prediction, and/or an entropy coding scheme.

According to a second aspect, there is provided a non-transitory computer-readable medium comprising computer executable instructions and a bitstream stored thereon. The computer executable instructions, when executed by a computing device, cause the computing device to perform any of the methods of the first aspect to generate the bitstream.

According to a third aspect, there is provided an encoder, comprising: one or more processors; and a non-transitory computer-readable medium comprising computer executable instructions stored thereon which when executed by the one or more processors cause the one or more processors to perform any of the methods of the first aspect.

According to a fourth aspect, there is provided a method of processing video data, performed by a decoder, the method comprising: decoding a bitstream to obtain video data and coding information; obtaining a plurality of reference pictures from the video data; upsampling the plurality of reference pictures to obtain a plurality of upsampled reference pictures; obtaining a weighted filter to reduce an overall error between the plurality of upsampled reference pictures and corresponding original pictures, by: determining a weighting map for each reference picture using a weighting map function, the weighting map comprising a plurality of weights mapped to respective spatial locations of the upsampled reference pictures, wherein the upsampled reference pictures are used as an input to the weighing map function, and determining a filter to be applied to the upsampled reference pictures with the respective weighting maps to obtain filtered upsampled reference pictures, such that the filter is applied with different weights to different spatial locations of the upsampled reference pictures; and performing inter prediction of a plurality of blocks of a first picture based on a plurality of reference blocks from one or more of the upsampled reference pictures, wherein the method further comprises: applying the weighted filter to the plurality of upsampled reference pictures prior to performing the inter prediction, or applying the weighted filter to upsampled referenced blocks of the reference pictures during the inter prediction.

In some embodiments, the method further comprises adding the obtained weighted filter to a stored reference filter set.

In some embodiments, the coding information comprises signalled weighting map function parameters, and wherein determining the weighting map using the weighting map function comprises: applying the signalled weighting map function parameters as parameters of the weighting map function; and providing the reference pictures or first picture as an input to the weighting map function.

In some embodiments, the coding information comprises signalled filter function parameters, and wherein obtaining the filter comprises: applying the signalled filter function parameters as parameters of the filter.

In some embodiments, applying the weighting map and the filter to the picture to obtain the filtered reference pictures or first picture takes place within the coding loop or as a post-loop step.

In some embodiments, the coding loop is a H.266/VVC coding loop.

In some embodiments, the step of applying the weighting map and the filter to the reference pictures or first picture to obtain the filtered picture is integrated into an adaptive loop filter and is applied to derived partitions.

In some embodiments, the bitstream is rate distortion (RD)-optimized based on an estimated signaling rate and distortion after applying the weighting map and the filter to the reference pictures or first picture.

In some embodiments, the reference pictures and/or picture comprise a luma-channel, a chroma channel or both, and wherein the weighting map and the filter are applied to the luma-channel, the chroma channel or both.

In some embodiments, which of the luma-channel and the chroma channel the weighting map and the filter are to be applied to is predetermined, signaled in the bitstream, or inferred from the picture's content.

In some embodiments, the method further comprises partitioning in the reference pictures and first picture into a plurality of partitions, wherein the weighting map and the filter are applied to one or multiple partitions of the reference pictures or first picture, wherein the partitions are signaled in the coding information.

In some embodiments, the partitions being signaled in the coding information comprises a signaled block-partitioning, signaled region partitioning criteria or a binarized weighting map function in the coding information.

In some embodiments, the method further comprises applying multiple filters to a same picture partition.

In some embodiments, the filter is configured to address the problem of ringing artifacts, blurring and/or blocking artifacts in the picture.

In some embodiments, determining the weighting map using a weighting map function comprises: applying a weighting map function which outputs a scalar weighting map, with the scalar being binary, integer or floating-point.

In some embodiments, determining the weighting map using a weighting map function comprises: applying a weighting map function which outputs a multi-dimensional weighting map, with each element being binary, integer or floating-point.

In some embodiments, the weighting map information for one or more channels of the reference pictures is computed using information from one or more channels of the reference pictures as input.

In some embodiments, a set of weighting map functions are predefined, and the coding information signals the weighting map function to be used.

In some embodiments, the weighting map functions are parametric.

In some embodiments, the coding information signals a plurality of weighting map functions, wherein determining the weighting map using the weighting map function comprises determining a plurality of weighting maps using the plurality of weighting map functions, and wherein applying the weighting map and the filter comprises applying one or more filters for each signaled weighted map.

In some embodiments, the filtering function and parameters of the filter are signaled in the coding information, pre-defined, inferred from the content of the video, or inferred from the coding information.

In some embodiments, the filter is a linear filter, and a shape of the filter is indicated in the bitstream or predefined.

In some embodiments, the linear filter is optimized by a least-squares optimization or RD-optimized.

In some embodiments, the linear filter is a parametric linear filter.

In some embodiments, the parametric linear filter is RD-optimized with regards to a minimal error at the output, derived by least squares optimization, iterative search, or exhaustive search.

In some embodiments, the filter is a bilateral filter.

In some embodiments, determining the filter comprises determining a plurality of filters, wherein applying the weighting map and the filter to the reference pictures or first picture comprises applying each filter of the plurality of filters at a location signaled in the bitstream or indicated in the weighting map.

In some embodiments, a parametric weighting map is optimised together with the filtering function.

In some embodiments, applying the weighting map and the filter to the picture comprises applying one or more filters to partitions of the reference pictures or first picture based on a block-partitioning signaled in the coding information.

In some embodiments, applying the weighting map and the filter to the reference pictures or first picture comprises applying one or more filters to partitions of the reference pictures or first picture based on derived region partitioning criteria.

In some embodiments, the filter and weighting map calculation parameters are encoded by a quantization, prediction, and/or an entropy coding scheme.

According to a fifth aspect, there is provided a non-transitory computer-readable medium comprising computer executable instructions and a bitstream stored thereon. The computer executable instructions, when executed by a computing device, cause the computing device to perform any of the methods of the fourth aspect to decode the bitstream to generate a video.

According to a sixth aspect, there is provided a decoder, comprising: one or more processors; and a non-transitory computer-readable medium comprising computer executable instructions stored thereon which when executed by the one or more processors cause the one or more processors to perform any of the methods of the fourth aspect.

According to a seventh aspect, there is provided a method of processing video data, performed by an encoder, the method comprising: obtaining original video data; performing a trial encoding of at least a part of the original video data into trial encoded video data; obtaining a trial first picture based on the trial encoded video data, by performing inter prediction of a plurality of blocks of the trial first picture based on a plurality of reference blocks from one or more reference pictures, the one or more reference pictures being at a lower resolution than the trial first picture; and obtaining a weighted filter to be applied to the plurality of inter predicted blocks of the trial first picture to reduce an error between the trial first picture and a corresponding original first picture in the original video data, by: determining a weighting map using a weighting map function, the weighting map comprising a plurality of weights mapped to respective spatial locations in each of the inter predicted blocks of the trial first picture, wherein the inter predicted blocks of the trial first picture are used as an input to the weighing map function, and determining a filter to be applied to the inter predicted blocks of the trial first picture with the weighting map, wherein the filter is configured to be applied, with the weighting map, to the inter predicted blocks of the trial first picture to obtain a filtered first picture, such that the filter is applied with different weights to different spatial locations in each of the inter predicted blocks of the trial first picture.

In some embodiments, the method further comprises: encoding the video data and coding information, the coding information comprising information on the weighting map function and/or filter to be used at a decoder.

In some embodiments, the method further comprises: determining whether a rate-distortion performance of the encoding of the video data and coding information is better than a rate-distortion performance of the trial encoding; based on the rate-distortion performance of the encoding of the video data and coding information being better than a rate-distortion performance of the trial encoding, including the encoded video data and coding information in a bitstream transmitted to a decoder; based on the rate-distortion performance of the encoding of the video data and coding information not being better than a rate-distortion performance of the trial encoding, including the trial encoded video data and in a bitstream transmitted to a decoder.

In some embodiments, the method further comprises adding the obtained weighted filter to a stored reference filter set.

In some embodiments, the trial encoding further comprises deriving trial prediction signals by a pre-analysis of the one or more reference pictures, the first picture, the corresponding original pictures in the original video data and/or coding information.

In some embodiments, the method further comprises iteratively performing the pre-analysis or trial encoding and the step of obtaining a weighted filter until a stopping criterion is met.

According to an eighth aspect, there is provided a non-transitory computer-readable medium comprising computer executable instructions stored thereon which when executed by a computing device cause the computing device to perform any of the methods of the seventh aspect.

According to a ninth aspect, there is provided an encoder, comprising: one or more processors; and a non-transitory computer-readable medium comprising computer executable instructions stored thereon which when executed by the one or more processors cause the one or more processors to perform any of the methods of the seventh aspect.

According to a tenth aspect, there is provided a method of processing video data, performed by a decoder, the method comprising: decoding a bitstream to obtain video data and coding information; obtaining one or more reference pictures; performing inter prediction of a plurality of blocks of a first picture based on a plurality of reference blocks from the one or more reference pictures, the one or more reference pictures being at a lower resolution than the first picture; obtaining a weighted filter to be applied to the plurality of inter predicted blocks of the first picture to reduce an error between the first picture and a corresponding original first picture, based on the coding information, by: determining a weighting map using a weighting map function, the weighting map comprising a plurality of weights mapped to respective spatial locations in each of the inter predicted blocks of the first picture, wherein the inter predicted blocks of the first picture are used as an input to the weighing map function, and determining a filter to be applied to the inter predicted blocks of the first picture with the weighting map, wherein the filter is configured to be applied, with the weighting map, to the inter predicted blocks of the first picture to obtain a filtered first picture, such that the filter is applied with different weights to different spatial locations in each of the inter predicted blocks of the first picture; and applying the weighted filter to the plurality of inter predicted blocks of the first picture.

In some embodiments, the method further comprises adding the obtained weighted filter to a stored reference filter set.

These and other aspects of the present application may become more readily apparent from the following description of the embodiments.

### BRIEF DESCRIPTION OF THE DRAWINGS

Embodiments will now be described, by way of example only, with reference to the accompanying drawings, in which:

FIG. 1 shows a flowchart of the operations of a decoder according to a first embodiment;

FIG. 2 shows a flowchart of the operations of an encoder according to the first embodiment;

FIG. 3 shows a block diagram illustrating example operations in the first embodiment;

FIG. 4 shows graph comparing a plurality of filtering schemes against a ground truth signal.

FIG. 5 shows a block diagram illustrating example operations in a variant of the first embodiment;

FIG. 6 shows a flowchart of the operations of a decoder according to a first embodiment;

FIG. 7 shows a flowchart of the operations of an encoder according to the first embodiment;

FIG. 8 shows a schematic illustration of a decoder according to various embodiments; and

FIG. 9 shows a schematic illustration of an encoder according to various embodiments.

### DETAILED DESCRIPTION

Technical solutions in the embodiments of the present application will be described clearly and completely below with reference to the accompanying drawings.

The VVC compression standard introduced Reference Picture Resampling (RPR) as a tool for adaptively changing the resolution within a Coded Layer Video Sequence. Unlike previous standards, the output resolution is not restricted to the resolution at which a given frame of the video sequence is coded. To achieve this functionality, a set of filters was introduced to facilitate switching between different resolutions.

The filters used for resolution change in the VVC standard are currently fixed linear filters. These filters are well suited for a wide range of video content. However, the content within coded video sequences is locally correlated and depends on the specific video sequence. Furthermore, image upscaling presents an inherently non-linear problem. To account for that, the embodiments discussed herein make use of an adaptive locally weighted filter. This is based on the assumption that optimizing a filter with the knowledge of errors caused by coding and the characteristics of the current frame improves the performance of the coding scheme.

Some arrangements support both the switching of coding resolution and, temporarily coding at lower resolution. Therefore, it necessitates both downsampling and upsampling procedures in order to switch resolution and to reference pictures of different resolution in inter-prediction. Some reference software employs a fixed upsampling procedure using interpolation filters for both of those applications. The upsampling is done by finite impulse response filters. While the resolution of the output device remains unchanged, the output itself still needs to be displayed at a high resolution. This third embodiment addresses two application scenarios. The first application scenario makes use of enhancement filters only inside the coding loop, i.e. the filters are not used to improve upscaled low-resolution pictures for the output. This involves changes to the upsampling procedure while keeping the downsampling procedure unaffected. As a result, the evaluation of these changes is most effectively conducted in the high-resolution domain.

Pictures coded at lower resolution often lack high frequency information which is present in their high-resolution equivalents. Consequently, pictures which were coded at low resolution usually appear blurred after upsampling. Consequently, the prediction error is usually higher if low-resolution frames are referenced. The issue stems from the fact that the upsampling process cannot recover high-frequency information which was lost during downsampling. However, artifacts caused by Reference Picture Resampling (RPR) are most pronounced in areas that do not align with the underlying assumptions of the interpolation scheme (i.e. smoothness). In the reference software, this is particularly evident in content containing high-frequency information, such as edges.

The current reference software employs a fixed set of downsampling and upsampling filters without utilizing any side information from the coded video or bitstream to enhance the quality of the upsampled picture or prediction signal. For example, the distribution of frequency components may differ depending on the coded video sequence or spatial location making the most optimal filter depend on the characteristics of the content. Current filtering methods, such as the adaptive loop filter, solve this problem by signaling a set of filters. The decision, which filter is applied to a given picture partition is signaled and may additionally be inferred from the picture content. However, in case of upsampled image content, there are different types of errors compared to in-loop filters. Typically, there is some blurring caused by down- and upsampling. For that reason, applying sharpening, especially at the edges, can be beneficial.

The embodiments discussed herein address limitations of the upsampling procedure in Reference Picture Resampling (RPR) and picture upsampling. Some current implementations takes a frame or block as input and apply a set of multi-phase interpolation filters to interpolate subsample positions. An issue is that the problem of image upsampling is inherently ill-posed. Therefore, no filtering method can solve this problem for an arbitrary type of content. However, side information which is inferred from the coded video or encoded in the bitstream may be used to amend this problem. The embodiments discussed herein can be applied by adding another processing step after the upsampling; namely, an adaptive locally weighted filter.

The underlying assumption is that the optimal strength of the filter depends on the spatial location and can be inferred from the content. Since the filter is least-squared optimized based on the applied weighting and the upsampled picture, there is an interdependency. Therefore, the overall performance of the filter depends on the initial choice of weighting function. Consider, for example, a filter which is least-squares optimized (without weighting) such that the result is added to the filtered picture to obtain the output. After this optimization, certain pixels may have an optimal, too large, too small or incorrectly signed computed offset. Now, if it were possible to compute a local weighting that reduced the offset applied by the filter at regions where the computed offset is too high or has the wrong sign and increase the offset at regions where it is too small, the error would be decreased. Additionally, since the weighting is known beforehand, a better filter could be optimized. However, finding a weighting map function which is optimal for each type of content and at every location in the picture is complex. Nonetheless, approximating the optimal weighting with a weighting map could already lead to improved results.

In the application of RPR upscaling, the content is usually blurred, especially in high-frequency structures such as edges. Linear filters usually exhibit ringing and overshoot artifacts, and the filtered edge frequently still has less steepness compared to the ground truth edge. Therefore, increasing the offset of the filter at the predicted location of the edge and decreasing it at the surrounding would improve the filter.

These technical solutions may be applied to a H.265/HEVC or H.266/VVC video coding system (e.g. in an in-loop process where other filters such as an adaptive loop filter (ALF) and sample adaptive offset filter (SAO) are currently applied in such coding processes). However, it is to be understood that these technical solutions may applied in any other video coding system that involves video compression. Furthermore, while these principles are primarily illustrated with reference to video processing, they are also applicable to other data forms, including image processing or even audio processing.

A “video” in the embodiments refers to one or more pictures. In other words, a video can include one picture or a plurality of pictures. A picture may also be referred to as an “image”.

An “encoder” is a device capable of encoding data into a bitstream, while a “decoder” is a device capable of decoding the bitstream in order to obtain the encoded data, or an approximation of the encoded data. A “bitstream” comprises a sequence of bits.

“Intra-prediction” and “inter-prediction” are two prediction operations that can be used within the HEVC and VVC frameworks for a decoder to process a received bitstream in order to obtain the original signal. In the embodiments, “original signal” or “original video” is used to refer to the data prior to encoding at the encoder. A reference sample in the embodiments may refer to spatially and/or temporally spaced picture data used for the prediction of a picture (or region of a picture). Intra and inter-prediction operations are also used at the encoder to make rate-distortion decisions.

In more detail, intra-prediction involves the prediction of data spatially within a single picture, without a reference to other (temporally spaced) pictures. In other words, data for a first region of a picture is used in the prediction of the data for another region of the same picture, but there is no dependence on another temporally spaced picture. In this context, the data for the first region of the picture is considered a “reference sample”.

Inter-prediction involves the prediction of data between a plurality of temporally-spaced pictures. In other words, data for a first region of a first picture is used in the prediction of data for a second region of a second picture. The first and second region may or may not be spatially separated from one another. In this context, the data for the first region of the first picture is considered a “reference sample”. It is further noted that inter-prediction may sometimes use multiple reference regions from different pictures at once, i.e. for a single prediction operation.

A “residual” in the embodiments may refer to value obtained based on an original value of a region of a picture and a prediction value of the region of the picture (e.g. the difference between the original value and the predicted value).

A “block” in the embodiments may refer to a portion of a picture. For example, a picture may be portioned into two or more blocks. However, this only an example. If a picture is not partitioned, then a “block” can refer to the entire picture.

A “filter” in the embodiments may refer to a filter that acts to enhance a signal, particularly an upsampled signal. In general, in the described embodiments, the filter is configured to sharpen blurred content, reduce ringing artifacts, and/or reduce blocking artifacts. However, embodiments are not limited to this and the filter can instead be configured to provide alternative or additional enhancements in other embodiments.

The general optimization problem in video coding is to minimize the transmission rate and the distortions at the same time. A lower transmission rate leads to stronger and more visible distortions which reduce the perceived quality of the viewer. The errors caused by the encoding are not random but caused by the processing steps in the encoder and decoder. Two important steps of a video coding system are the prediction and transformation. The quantization of the transform coefficients induces the reconstruction errors. Many video coding systems employ a hybrid coding structure, where the content of a block is predicted by intra- or inter prediction. This prediction is usually not perfectly accurate. Consequently, the difference of the ground-truth signal is calculated, transformed and encoded to compensate for the prediction error. The signal after the addition of the residual is filtered by so-called in-loop filters.

The processing steps that cause artifacts are not random. Embodiments of the invention make use of prior information to address specific types of errors.

Two useful applications are the reduction of ringing artifacts and the sharpening of edges. Those two problems can be hard to address with linear filters. The weighted filter of embodiments of the invention employs a straightforward concept to overcome the limitations of conventional linear filters. The idea is to apply two filters. The first extracts local information from the decoded picture. The second filter applies a filtering which depends on the output of the first filtering setup. In some embodiments, the second filter would be RD-optimized depending on the output of the first filter. With that, non-linear filters that are adaptive to certain picture features can be signaled.

Furthermore, as discussed above, current video coding schemes such as H.265/HEVC (High Efficiency Video Coding) and H.266/VVC (Versatile Video Coding) support spatial scalability of the coded video stream. As such, the spatial resolution at which a video is coded may change adaptively and no longer needs to be equivalent to the output or input resolution of the video. The advantages of this additional flexibility are that coding a lower resolution video requires a lower bitrate and may reduce computational complexity at the cost of losing high frequency information in the downsampling step.

In reference picture resampling (RPR), for example, the resolution of the coded video stream may change adaptively. Consequently, the encoder may code parts of the video stream at lower resolution. RPR is applied in the inter-prediction every time that a picture uses a reference picture of different resolution than the current picture in inter prediction. In this step, a resampling operation needs to be applied such that the referenced picture block is mapped to the same spatial resolution as the current picture.

Finding optimal high-resolution representations from the low-resolution pictures are an important part of these coding schemes. One method is to apply a set of multi-phase Finite Impulse Response (FIR)-interpolation filters to a low-resolution picture. While those filters do provide an approximation of the high-resolution image content, they cannot recover information that was lost in the downsampling process and suffer from limitations of the linear filtering operation. Consequently, upsampled images are often blurred.

An image sharpening operation can increase the picture quality. However, linear high-pass filters frequently cause artifacts such as overshoot and ringing. Moreover, the distortions caused by the down- and upsampling depend on the image content and the coding quality of the video (influenced by the Quantization Parameter (QP) value).

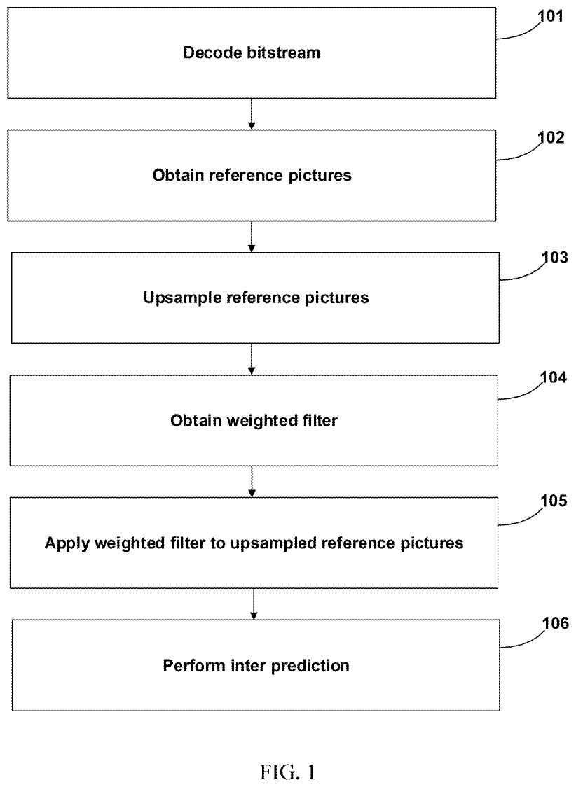

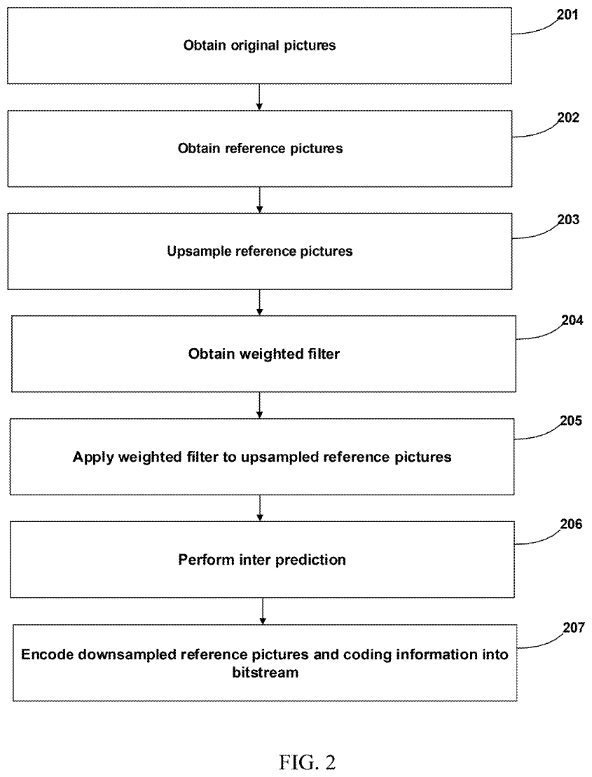

FIG. 1 shows a flowchart of the operations of a decoder 80 according to a first embodiment. FIG. 2 shows a flowchart of the operations of an encoder 90 in accordance with this embodiment.

The flowchart of FIG. 1 starts a step 101, in which the decoder 80 decodes a bitstream to obtain video data and coding information. In this embodiment, the coding information includes weighting map information.

At step 102, the decoder 80 obtains (or “reconstructs”) a set of reference pictures based on the video data. The video data comprises a compressed version of original video data. In this embodiment, step 102 involves obtaining a set of temporally spaced pictures (or “frames”) according to the prediction schemes specified in H.266/VVC, which are then stored as reference pictures (e.g. for future inter-prediction of future pictures). However, embodiments are not limited in this respect and any other method of obtaining a set of reference pictures from encoded video data can be used instead in other embodiments. Examples include the prediction schemes specified in H.265/HEVC.

At step 103, the decoder 80 upsamples the reference pictures. In detail, in this embodiment, the reference pictures have been encoded in the bitstream at a lower resolution, while a next picture (or “frame”) has been encoded at a higher resolution. As such, the reference pictures are upsampled to the resolution of the next picture in order to be used as reference pictures for inter prediction of one or more blocks of the next picture.

In this embodiment, step 103 involves applying a set of multi-phase FIR-interpolation filters to reconstruct intensity values at fractional sample positions, so as to increase a resolution of each of the reference pictures. However, embodiments are not limited to this, and other methods of upsampling can be applied instead. In particular, there are many different methods that can be used for performing the interpolation. Basically, we have the problem in upsampling that fractional sample positions need to be interpolated. Those include bilinear interpolation, bicubic interpolation, nearest neighbour interpolation, and lanczos interpolation), to name a few.

At step 104, the decoder 80 obtains a weighted filter to reduce an overall error between the plurality of upsampled reference pictures (or blocks) and corresponding original pictures (or blocks), using the weighting map information. In this embodiment, the weighting map information comprises a weighting map function to be used to calculate the weighting map for each reference picture. Each weighting map comprises a plurality of weights mapped to respective spatial locations of the upsampled reference pictures, wherein the upsampled reference pictures are used as an input to the weighing map function.

One such example is that, when a sharpening filter is to be used, the weighting map information comprised in the coding information is a local gradient calculation function. In such an example, at step 104, for each upsampled reference picture, the decoder 80 applies the gradient calculation function to calculate the gradient at each location in the upsampled reference picture, thereby arriving at a scalar weighting map having a same resolution as that of the upsampled reference picture (with a value corresponding to each respect location in the picture). In other words, the reference picture is provided as an input to the weighting map function.

Furthermore, in other embodiments, the weighting maps may have a different resolution to the upsampled reference pictures and/or may comprise vector values rather than scalar values. Furthermore, it will be appreciated that the example of a picture gradient function is just an example, and that in practical implementations of embodiments, the choice of appropriate weighting map function will depend on the circumstances, particularly which filter is to be used. These factors and possible variants will be discussed in more detail later.

Furthermore, while it has been discussed in this embodiment that the coding information comprises weighting map information which comprises a weighting map function, embodiments are not limited in this respect. For example, in some embodiments a plurality of weighting map functions are stored at the decoder 80. In such cases, the weighting map information instead comprises an indication of which weighting maps to use. Moreover, in some embodiments, the coding information does not comprise any explicit weighting map indication. Instead, for example, the coding information may comprise filter information, with the decoder 80 then inferring the weighting map function to be used (e.g. if the coding information indicates that a sharpening filter should be used, the decoder infers that a picture gradient function should be used as the weighting map function). These factors and possible variants will be discussed in more detail later.

At step 104, the decoder 80 also determines a filter to be used with the weighting maps. In this embodiment, the decoder 80 infers the filter to be used from the weighting map information. As discussed above, in one example, the weighting map information comprised in the coding information is a local gradient calculation function. In this example, the decoder 80 can infer that a (e.g. pre-stored) sharpening filter should be used in conjunction with weighting maps that comprises picture gradients.

At step 105, the decoder 80 applies the filter and respective weighting map (together named a “weighted filter”) to each of the reference pictures to obtain a plurality of enhanced reference pictures. Hence, step 105 involves using the determined weighting map so that the filter is applied with different strengths to different regions of each of the upsampled reference pictures. However, step 105 is optional, as discussed further later.

In this embodiment, applying the weighting map and filter to an upsampled reference picture involves providing both the upsampled reference picture and weighting map as inputs to the filter. This results in the filter being applied with different strengths to each value of the upsampled reference picture, depending on the value of the respective weight in the weighting map. The output of the filter is a map of offset values. The map of offset values in this embodiment corresponds in resolution to the upsampled reference picture. Once the map of offset values is output, the offset values are then added to the values of the upsampled reference picture to result in an output (enhanced) reference picture.

In the above discussion, it is assumed that the filter is a sharpening filter configured to sharpen blurred edges. However, embodiments are not limited to this, and any suitable filter for enhancing the picture can be used instead.

At step 106, the decoder 80 performs inter prediction of a plurality of blocks of a first picture based on a plurality of reference blocks from one or more of the enhanced upsampled reference pictures. Specifically, the decoder 80 performs a prediction operation using the enhanced reference pictures to obtain a plurality of prediction blocks of the first picture. In more detail, the decoder 80 performs inter-prediction using the enhanced reference pictures as reference pictures, to obtain the prediction blocks.

Following step 106, the predicted first picture can then be used for any desired purpose. In one example, the decoder 80 then displays this to a viewer. In another example, the decoder 80 stores the first picture for later use. In another example, the decoder 80 transmits the first picture to an external device for display.

In some embodiments, the obtained weighted filter is added to a stored reference filter set for future use.

As mentioned above, step 105 is optional. This is because, instead of applying the weighted filter to the plurality of reference pictures the weighted filter can instead be applied to upsampled referenced blocks of the reference pictures during the inter prediction (but before addition of the residual). Note that both alternatives are equivalent (besides rounding) and are just different implementations. Hence, in a variant of this embodiment, step 105 is not applied, and the weighted filter is instead applied to the first picture after the inter prediction has been performed (but before addition of the residual).

A complementary method can be performed by the encoder 90 in order to encode the bitstream provided to the decoder 80. FIG. 2 shows a flowchart of the operations of the encoder 90 according to this embodiment.

At step 201, the encoder 90 obtains a plurality of original pictures from original video data. For example, the encoder 90 may receive the original video data through a communication network (e.g. the internet) from an external server. However, there is no limit in the embodiments as to how the original video data is obtained.

At step 202, the encoder 90 obtains a plurality reference pictures, each corresponding to an original picture from the original video data, wherein the plurality of reference pictures are at lower resolutions than the original pictures from the original video data. For example, the plurality of reference pictures may represent previous pictures (or “frames”) which have been encoded into a bitstream at a lower resolution than the corresponding original pictures from the original video data (i.e. they may be the pictures that are decoded at the decoder based on an encoded bitstream), for example to account for network conditions at the time of said encoding. These previous pictures may be stored in the decoder and encoder as a reference frame set in order to be used for inter prediction of future pictures. As such, each reference picture corresponds to an original picture form the original video data (though there are differences due to the lower resolution and possible prediction errors in obtaining the reference pictures).

At step 203, the encoder 90 upsamples the plurality of reference pictures. Step 203 takes place in a corresponding manner to step 103 of FIG. 1 and a detailed description is omitted here for brevity.

At step 204, the encoder 90 obtains a weighted filter to reduce an overall error between the plurality of upsampled reference pictures (or blocks) and the corresponding original pictures (or blocks). This step involves both determining a weighting map for each reference picture using a weighting map function, the weighting map comprising a plurality of weights mapped to respective spatial locations of the upsampled reference picture, wherein the upsampled reference pictures are used as an input to the weighing map function, and determining a filter to be applied to the upsampled reference pictures with the respective weighting maps to obtain filtered upsampled reference pictures, such that the filter is applied with different weights to different spatial locations of the upsampled reference pictures.

In performing step 204, the encoder 90 determines a combination of weighting maps and filter to be used to enhance the plurality of reference pictures by applying the filter with different weights to different regions of the upsampled reference pictures.

In order to determine a combination of weighting maps and filter that enhances the picture, step 204 may involve a rate distortion (RD) optimization process involving iteratively applying a plurality of filters with a plurality of weighting maps to the upsampled reference pictures. For each application, an average total difference in values between the resulting upsampled reference pictures and corresponding pictures from the original video data are determined. This cycle continues until a stopping criterion is met (e.g. an optimum weighting map has been determined for a particular filter).

In other words, an RD-optimization process takes place at the encoder, based on estimated signaling rate and distortion of the obtained pictures.

A first example of a suitable stopping criterion is that a particular combination of filter and weighting maps results in an average absolute difference (or average squared difference) of values between the resulting plurality of pictures and corresponding pictures from the original video data being less than a predetermined threshold difference. A second example of a suitable stopping criterion is that an average absolute difference (or average squared difference) of values between a weighting map of the current iteration of the iterative process and a weighting map of the previous iteration of the iterative process is less than a second predetermined threshold difference. The first example of a suitable stopping criterion directly measures the output quality and therefore can be assumed to result in higher ultimate picture quality than the second example. However, the second example ensures that the iterative process does not require excessive computation time. In some embodiments, both of these examples are used, and the iterative process stops when either one of these two stopping criteria is met.

In the example discussed above with regard to FIGS. 1 and 2, a single (sharpening) filter is used (with a corresponding weighting map). However, while this embodiment has been discussed with regard to finding a single combination of filter and weighting map, embodiments are not limited in this respect. For example, in some embodiments, the encoder may identify a plurality of combinations of weighting map and different types of filter to be used.

The method of FIG. 2 then continues to step 205, in which the encoder 90 applies the filter and respective weighting map (together named a “weighted filter”) to each of the reference pictures to obtain a plurality of weighted reference pictures. Step 205 takes place in a corresponding manner to step 105 of FIG. 1 and a detailed description is omitted here for brevity. However, step 205 is optional, as discussed further later.

At step 206, the encoder 90 performs inter prediction of a plurality of blocks of a first picture based on a plurality of reference blocks from one or more of the enhanced upsampled reference pictures. Similarly to step 205, step 206 involves a rate-distortion optimization operation to determine inter prediction parameters to then be encoded into the bitstream. However, embodiments are not limited thereto, and any form of inter-prediction can be performed instead.

At step 207, the encoder encodes the video data and coding information into the bitstream, the coding information comprising weighting map indication information indicating the particular weighting map for each reference picture.

In some embodiments, the obtained weighted filter is added to a stored reference filter set for future use.

As mentioned above, step 205 is optional. This is because, instead of applying the weighted filter to the plurality of reference pictures the weighted filter can instead be applied to upsampled referenced blocks of the reference pictures during the inter prediction (but before addition of the residual). Note that both alternatives are equivalent (besides rounding) and are just different implementations. Hence, in a variant of this embodiment, step 105 is not applied, and the weighted filter is instead applied to the first picture after the inter prediction has been performed (but before addition of the residual).

Through the methods discussed with reference to FIGS. 1 and 2, it can be seen that there is an in-loop filtering method which is applied inside the encoding loop of a video compression system. The in-loop weighted filter employs a function for calculating a local weighting/parameter map and a filtering function. The weighting map function makes use of the input picture and optionally coding information/signaled parameters to calculate the weighting map. The filtering function makes use of the input picture, weighting/parameter map, and optionally coding information/signaled parameters to calculate the filtered picture.

According to this method, by applying a filter with local weightings, it is possible to increase coding performance and allow for a wider range of applications. Through the use of a weighting function to determine a weighting map, a weighted filtering can be used with weights to guide the properties of a filter at each spatial location. For example, the strength of a sharpening filter can be increased at locations of a picture which are close to edges and decreased at regions which are further away from edges. With that, ringing artifacts and overshoot might be reduced while maintaining sharpening properties.

In some examples, the optimisation discussed with reference to step 204 of FIG. 2 involves iterating between filter and weighting map function parameters. For example, starting parameters for a weighting map are set, and then the filter parameters are optimised based on the current weighting map. Then the weighting map parameters are optimised based on the found filter parameters and so on. In such cases, the coding information would comprise information on the weighting map function as well as the filter function (e.g. the parameters to be used). Of course, this is a basic form of optimization procedure. In some cases, additional side constraint can be set, for example in order to not only determine the best filter and weighting map in terms of picture quality but also to have the coding rate as low as possible. This can be achieved by introducing those conditions in both of those individual optimizations and selecting the starting point for the next iteration under consideration of rate costs as well. More generally, it is possible to additionally introduce simplifications that limit the computational costs.

In this embodiment, the weighting map provides linear weightings for the filter. However, embodiments are not limited to this, and in other embodiments, the values of the weighting map can instead modify the filtering procedure itself. For example, the filter could be parametric. For example, the frequency response of an edge enhancement filter could be dependent on the local weighting map parameter. For example, the sigma value in unsharp masking (one type of sharpening filter) could be dependent on the weighting parameter. That means that the way that the filter works or more specifically, the function of the filter is parametric and not necessarily linearly dependent of the weighting map. Another example is a filter that does an edge thinning (sharpening) by warping the picture. The strength of the warping could depend on the current weighting map value.

In this embodiment, the weighted filter is applied in-loop. However, embodiments are not limited to this particular order, and a weighted filter may be applied at other processing steps additionally or alternatively in other embodiments, such as post-loop.

As discussed above, in this embodiment, the encoder 90 optimizes the weighted filter for a high-resolution picture based on the reference picture set and their corresponding ground-truth pictures. That means that the filter is RD-optimized such that the error between the upscaled and filtered low-resolution reference pictures and their ground-truth is minimized. This is done under the premise that a better reference set, i.e. enhanced reference pictures leads to an improved prediction of the current picture which results in a better rate-distortion performance for the current picture.

In this embodiment, step 204 of FIG. 2 involves optimizing one filter such that it produces the minimum error after being applied to the set of low-resolution reference pictures. Thereby, pᵢ are the reference pictures and gᵢ the ground-truth pictures corresponding to those pictures, as shown in equation (1):

$$min {\sum }_{i} {f}_{loss} ( {f}_{filter} ( {p}_{i} ) , {g}_{i} ) + {R}_{filter} \qquad ( 1 )$$

However, embodiments are not limited in this respect and other factors can also be taken into account. For example, in a variant of this embodiment, temporal proximity is also taken into account. Thereby, the loss of each of the reference pictures is weighted by an importance weighting factor wᵢ such that pictures which are temporally closer to the first picture (i.e. the picture for which inter prediction is to be performed) are weighted more than pictures with larger temporal distance. This is shown in equation (2):

$$min {\sum }_{i} {w}_{i} {f}_{l o s s} ( {f}_{filter} ( {p}_{i} ) , {g}_{i} ) + {R}_{filter} \qquad ( 2 )$$

In other variants, other factors are taken into account when determining the importance weighting factor wᵢ, including other coding factors such as the coding quality of the coded reference picture.

Furthermore, in some embodiments, a spatial weighting is possible. Thereby, motion vector data or other coding information of the reference picture can be used to find a local weighting of the loss function.

For example, the weighting of reference pictures and reference picture areas may be derived based on an analysis of the reference pictures using coding information and the content of all available and previously coded pictures.

As such, it can be determined which reference pictures (and which parts of these reference pictures) should be assigned the highest importance weighting factor wᵢ. For example, if the video data relates to a basketball game, importance weighting factor wᵢ could be assigned heavily based on the temporal positions of the pictures (i.e. a higher weighting for the most recent temporal pictures). Because there is rapid movement in a basketball game, it is likely that the most recent pictures will be the most relevant pictures for performing inter prediction of the next picture. However, if the video data relates to much slower moving objects (e.g. showing the sky with clouds hardly moving), then less importance is placed on the temporal position of the frame. Instead, a higher importance could be placed on a particular reference picture (or part of a reference picture) which shows the sky in high quality (e.g. with little blurring) because this is the most likely reference picture (or part of the reference picture) to be used for the inter prediction.

In relation to this, trial encoding (with potentially restricted tools) could be done to get an estimate of which areas are more important for the filter optimization. For example, this trial encoding could be done to determine which blocks of which reference pictures are the most likely to be used in the encoding of the first (to-be-predicted) picture, such that high importance weights can be applied to those areas.

Restricted tools refers to doing simplifications in the encoding of the picture (or block or slice). While this may reduce the quality of the filter (chosen blocks might be different), it also allows for the run-time to be reduced.

Options for restriction/simplification include:
testing a smaller number of intra/inter-modes in the prediction (i.e. switching off some tools). Examples include switching all intra tools except directional, planar and DC mode off/only checking for affine and normal inter-prediction but not using more complex tools such as decoder side motion vector derivation (DMVD) or linear illumination compensation (LIC);
using early stopping in the block partitioning or a restricted set of partitions; and
trial encoding at lower quality (which usually takes less time).

More generally, it can be seen that the importance weighting factor w can be assigned to a reference picture (or part of a reference picture) based on how likely it is that the reference picture will be used in the inter prediction.

To summarize this variant: Given the set of reference pictures pᵢ, the corresponding ground-truth pictures gᵢ and a set of reference filters wᵢ (from previous pictures), the weighted filter is optimized by the following steps:
1. Compute an importance weighting for the reference pictures
2. Compute an RD-optimized filter such that the weighted loss between the filtered pictures and their corresponding ground truths is minimized while considering the rate

$$R {D}_{l o s s} = R {D}_{filter} + {\sum }_{i} {f}_{l o s s} ( w ( coding data , {p}_{0} , … , {p}_{n} , {g}_{0} , … , {g}_{n} ) {f}_{filter} ( {p}_{i} ) , {g}_{i} )$$

3. Assign the filter to the current (high-resolution) picture and apply it to all inter-predicted blocks before the residual is added or apply it to all low-resolution pictures to generate high-resolution references. Note that both alternatives are equivalent (besides rounding) and are just different implementations.
4. Add the filter to the reference filter set

As an overview of this method of the first embodiment, this weighted filter is applied as an enhancement filter for inter-prediction and upscaled output picture enhancement. One filter may be optimized for each low-resolution picture. The distortion may be given by the encoding costs of the picture and the filter. The distortion may be the distortion after the filter is applied. A filter is chosen, if the RD-costs are lower with the filter being applied. This filter may then be used to enhance any upscaled content that was generated from this picture. Consequently, the same filter may be used, if the filter is output (i.e. written as upscaled picture) and if a block of this picture is referenced.

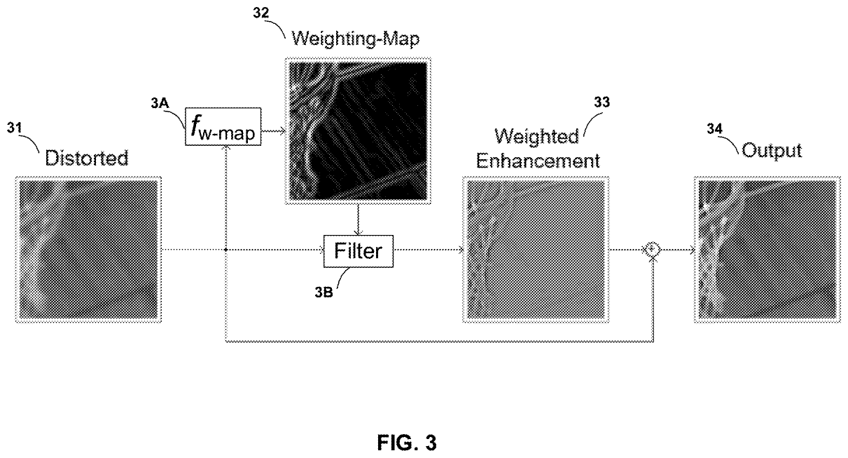

To illustrate the principles discussed above with reference to the embodiment of FIG. 1 and FIG. 2, an illustrative example will now be discussed with reference to FIG. 3.

FIG. 3 shows a block diagram illustrating example operations according to the embodiment of FIG. 1 and FIG. 2 discussed above. In other words, FIG. 3 shows a conceptual diagram of how the weighted filter could be implemented.

As can be seen in the process of FIG. 3, a distorted picture 31 is eventually turned into an (enhanced) output picture 34.

The distorted picture corresponds an upsampled reference picture discussed with reference to, for example, step 103 of FIG. 1.

The inputs may be the decoded, upscaled picture or block and side information which is encoded in an adaption parameter set in the bitstream. First, the filter parameters are decoded. This may include information regarding the weighting map function, filter shape, luma and chroma flags, and filter coefficients. Next, the weighting map function is applied to obtain the local weighting map. Then, the filter is applied to the upscaled picture or block to generate a filtered map. The filtered map is multiplied by the local weighting and added to the upsampled picture

With reference to step 104 of FIG. 1, for example, this distorted picture is then provided as input to the weighting map function (f_{w-map}) 3A that has been determined based on the coding information to result in the weighting map 32. In this particular example, as discussed above, the weighting map function 3A is a local gradient calculation function. As such, the weighting map 32 comprises a plurality of values of the picture gradient at each spatial location in the distorted picture 31.

Still with reference to step 104 of FIG. 1, the filter 3B is determined. As discussed above, in this embodiment, the decoder 80 infers the filter to be used from the weighting map information. As also mentioned above, in this example, the weighting map information comprised in the coding information is a local gradient calculation function. Hence, in this example, the decoder 80 infers that a (e.g. pre-stored) sharpening filter should be used in conjunction with the weighting map that comprises picture gradients.

With reference to step 105 of FIG. 1, the decoder 80 then applies the weighting map 32 and filter 3B to the distorted picture 31 in order to obtain the output picture 34. As can be seen in FIG. 3, this step involves provided the distorted picture 31 and weighting map 32 as inputs to the (sharpening) filter 3B, which thereby results in a weighted enhancement map 33. This weighted enhancement map 33 comprises a plurality of offset values respectively spatially corresponding to values of the distorted picture 31.

Next (as a part of step 105 of FIG. 1), the decoder 80 adds the offset values from the weighted enhancement map 33 to the respective values of the distorted picture 31 in order to arrive at the output picture 34.

Through this method, it can be seen that the blurring has been reduced without any significant issues regarding ringing artifacts and overshoot that can be caused by sharpening filters. This has been achieved through the local weighting of the sharpening filter, ensuring that it is not merely uniformly applied to the entire picture, but instead applied at different strengths to different spatial parts of the picture, depending on the properties of those spatial parts.

In more detail, the strength of the sharpening filter has been increased at locations of the picture which are close to edges and decreased at regions which are further away from edges. With that, ringing artifacts and overshoot are reduced while maintaining sharpening properties.

Note that in some embodiments, the addition of the offset map is incorporated into the filter function. However, for the purpose of better visualization, those operations are shown as separate steps in FIG. 3.

Furthermore, as will be discussed in more detail later, in some embodiments, both (or either of) the weighting map and the filtering function can be parametric functions which depend on parameters signaled in the bitstream.

It can be seen that the weighted filter comprises two main components. The weighting-/parameter-map calculation function and a (possibly parametric) filter.

First, the weighting map is calculated. In this embodiment, the weighting map is calculated at every point of the picture (though in other embodiments, it can be calculated at lower resolution). Next, the filter is applied. Thereby, the weighting-/parameter-map and the decoded picture are input to the filter. With that, the filtered picture is generated.

In the embodiment of FIGS. 1 and 2, the method is applied to the luma channel. However, embodiments are not limited in this respect. In other embodiments the method is applied to only a chroma channel, or to both a luma channel and a chroma channel. In other words, in some embodiments, both (or either) of the weighting-/parameter-map calculation function and the filter may be different for different channels. Hence, separate information/parameters may be signaled for luma and chroma components.

In this embodiment, the weighted filter replaces both the SAO and ALF of the VVC/H.266 system.

However, embodiments are not limited in this respect. For example, in other embodiments, the weighted filter replaces only one of SAO or ALF, or is provided in addition to the SAO and ALF. In another example, the weighted filter can be integrated into the ALF such that each of the partitions of the picture can be either filtered by an optimized linear filter or by the weighted filter. With that, the ALF would gain additional flexibility. For maximum flexibility, the filter may be added at any point in the chain of in-loop filters.

While these specific examples have been discussed, it will be appreciated that embodiments are not limited to the H.266/VVC scheme in this way. In other embodiments, the weighted filter is applied in a different coding scheme altogether (e.g. H.265/HEVC or any other suitable coding scheme).

Furthermore, in other embodiments, the weighted filter is applied as a post-filter to enhance the quality of coded videos. This can be beneficial if the back-coupling (from in-loop filtering) would lead to worse predictions of subsequent pictures. In such cases, an out of loop/post-filtering would be beneficial. Such determinations can be made by the encoder when performing encoding, in embodiments.

Hence, more generally, in embodiments the weighted filter can be integrated into the coding loop as an additional processing step of existing schemes, as alternative to an already existing loop filter or integrated into an already existing loop filter.

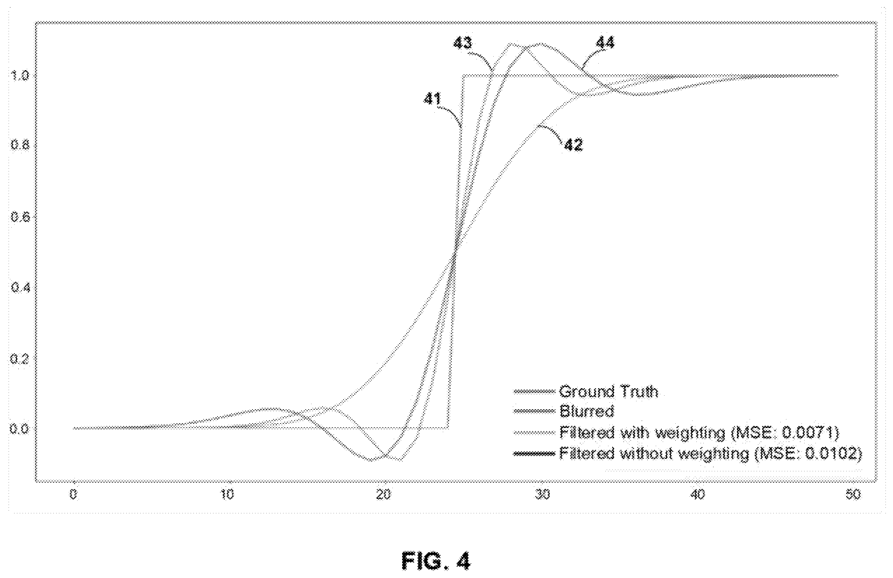

To further explain the concept of the weighted filter discussed above, another example implementation with now be discussed with reference to FIG. 4. FIG. 4 shows graph comparing a plurality of filtering schemes against a ground truth signal.

Let there be a blurred edge x as input of a filter. A ground truth signal 41 (shown in FIG. 4) is a step function. For simplicity and ease of visualization, a one-dimensional signal is shown. Note that this is done only to explain the concept in a simple way. In general, the methods discussed herein may be applied to signals of arbitrary dimension.

The graph of FIG. 4 shows four lines. There is the ground truth signal 41, a blurred signal 42 (e.g. corresponding to the distorted 31 of FIG. 3), a weighted filtered signal 43 (e.g. corresponding to the output picture 34 of FIG. 3), and a non-weighted filtered signal 44 (e.g. corresponding to the output picture 34 of FIG. 3 if the weighting map had not been used i.e. if only the filter was used).

In the non-weighted filtering the blurred signal 42 is filtered by a least-squares optimized linear filter in order to approximate the original signal as precisely as possible, thereby arriving at the non-weighted filtered signal 44. It can be seen in FIG. 4 that this type of filtering does increase the steepness of the edge to thereby provide a better approximation of the ground truth signal 41, but causing an overshoot and ringing which is non-optimal.

A better result is achieved if the high-pass characteristic of the filter is stronger at the steepest part of the edge and less strong at the region where ringing and overshoot artifacts are caused by the filter. To achieve this, in the weighted signal 42, the offset of the filtered blurred edge compared to the blurred edge is scaled by a larger factor at the predicted location of the edge and scaled by a small factor if there are overshoot or ringing artifacts expected. For that, a local weighting is calculated from the picture (i.e. the weighting map is calculated). For example, (and as discussed above with regard to FIGS. 1 to 3), the magnitude of the gradient approximated by finite differences can be used. For optimal results, the filter would then be optimized considering the local weighting.

As shown in FIG. 4, the weighted filtered signal 43 has a smaller error compared to the non-weighted filtered signal 44, relative to the ground truth signal 41. Moreover, in this example it can be seen that the overshoot is at a similar level for the weighted filtered signal 43, but the steepness of the signal and the ringing is not as severe (i.e. it has similar amplitude but it flattens out earlier).

From this example it can be seen that local adaptivity is beneficial to increase the performance of a filter if the characteristics of the signal and error are known. The adaptive loop filter (ALF) approaches this by applying different filters depending on the picture characteristics. This allows for more flexibility, but at the cost of increased bitrate.

Embodiments of the present invention make use of weighted (possibly parametric) filters to reduce the need for the use of many different filters. The shown example is one application case, where a single weighted filter might replace a set of filters while achieving similar results. This is particularly applicable where there are dependencies which can be exploited by a local parametrization.

In this embodiment, it has been discussed that the coding information comprises weighting map information which comprises a weighting map function. However, embodiments are not limited in this respect. For example, as discussed above, in some embodiments a plurality of weighting map functions are stored at the decoder 80. In such cases, the weighting map information instead comprises an indication of which weighting map to use. Moreover, in some embodiments, the coding information does not comprise any explicit weighting map indication. Instead, for example, the coding information may comprise filter information, with the decoder 80 then inferring the weighting map function to be used (e.g. if the coding information indicates that a sharpening filter should be used, the decoder infers that a picture gradient function should be used as the weighting map function).

In the embodiment discussed above with reference to FIGS. 1 and 2, the weighted filter is applied in an in-loop manner, specifically within the VVC/H.266 system.

Generally, in-loop filters may be applied at every point inside the coding loop. However, the order of application can have an impact on the overall performance since most loop filters are non-linear. One example of a video coding system is VVC/H.266. In this system, there are four in-loop filters which are applied sequentially. Those are luma mapping with chroma scaling (LMCS), de-blocking, sample adaptive offset (SAO) and the adaptive loop filter (ALF). The LMCS addresses very different errors than the proposed filter and inverse mapping should be applied before the proposed filter to avoid artifacts. Moreover, it makes sense to apply the de-blocking filter before the proposed method.

While particular implementations of the invention have been discussed above, a number of variations can be made in other embodiments, which will now be discussed, particularly with regard to the choice of weighting map function, the filtering function, region partitioning and the signaling.

As is apparent from the above discussion, the weighting map provides one or more weights/parameters to the filter. In other words, the filter is a parametrical function with the weighting map and the picture (and possibly coding parameters) as input.

Regarding the weighting map, in the embodiment of FIGS. 1 and 2, the weighting map is a scalar map. In this scalar map, each spatial location has exactly one value assigned to it. However, in other embodiments, the weighting map is a multi-dimensional map. In such embodiments, there is a vector of values at each spatial location. It should also be noted that, in embodiments of the invention, the spatial size of the weighting map is not restricted to the resolution of the picture. Depending on the requirements, in some embodiments it might be of smaller resolution to reduce computational complexity. The optimal choice of weighting map function heavily depends on the type of errors that are addressed by the filter and the type of filter that is applied to deal with those errors.

As discussed above, in the embodiment of FIGS. 1 and 2, applying the weighting map and filter to a reference picture/inter predicted picture (step 105 in FIG. 1) involves providing both the picture and weighting map as inputs to the filter. This results in the filter being applied with different strengths to each value of the picture, depending on the value of the respective weight in the weighting map. The output of the filter is a map of offset values, and the map of offset values corresponds in resolution to the picture. Once the map of offset values is output, the offset values are then added to the values of the picture to result in an output (enhanced) picture. An example of this is shown in FIG. 3, for example, which has been discussed above.

However, embodiments are not limited to this particular implementation. In an alternative, simple implementation, the strength values (i.e. weights of the weighting map) are used by the filter to scale the offset which is generated by the filter. This is done by multiplying the strength value (i.e. weight) by the difference between the output of the filter and the obtained picture. Adding this scaled difference to the obtained picture then changes the offsets generated by the filter depending on the computed weights. Consequently, the effect of the applied filter is different depending on the spatial location.

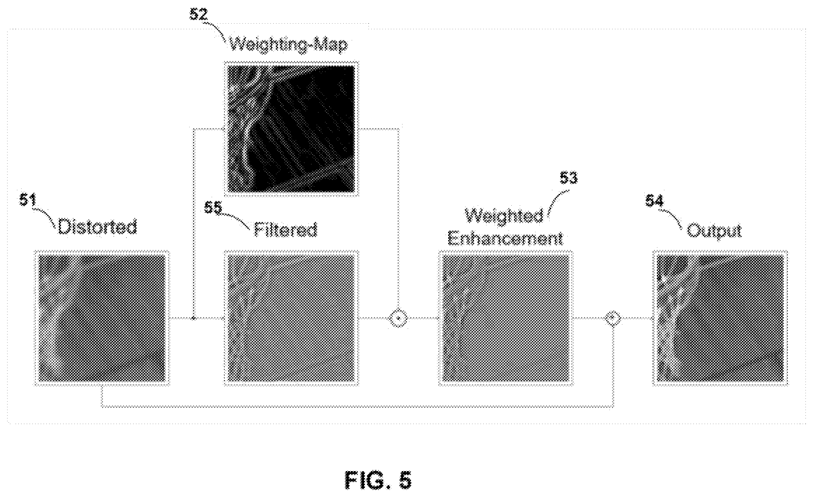

An example of this setup is shown in FIG. 5, which shows a block diagram illustrating example operations of this alternative method.

It can be seen that the method of FIG. 5 involves the distorted picture 51 being provided as an input to the weighting map and, separately, being provided as an input to the filter. The strength values (i.e. weights) of the resulting weighting map 52 are then multiplied by the difference between the output of the filter 55 and the distorted picture 51. Adding this scaled difference to the distorted picture 51 then changes the offsets generated by the filter depending on the computed weights.

In other words, a scalar weighting is computed to weight the output of the filter by sample-wise multiplication. The computed offset is added to the input picture to get the output.

From a comparison with the example of FIG. 3, it can be seen that, rather than the weighting map 52 being applied as an input to the filter, its values are instead simply multiplied by an output from the filter (specifically the difference between the output of the filter 55 and the distorted picture 51).

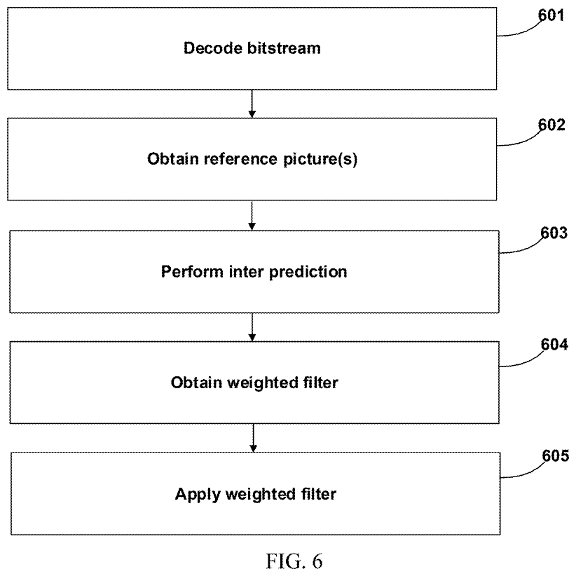

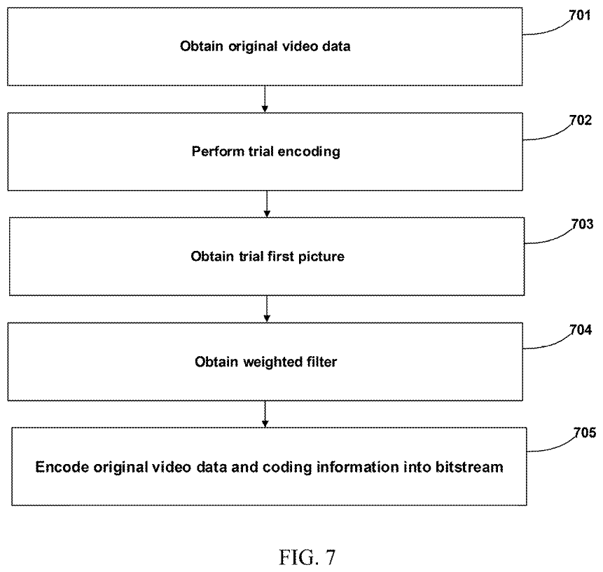

FIG. 6 shows a flowchart of the operations of a decoder 80 according to a second embodiment. FIG. 7 shows a flowchart of the operations of an encoder 90 in accordance with this second embodiment.

The flowchart of FIG. 6 starts a step 601, in which the decoder 80 decodes a bitstream to obtain video data and coding information. In this embodiment, the coding information includes weighting map information.

At step 602, the decoder 80 obtains one or more reference pictures. Step 602 takes place in a corresponding manner to step 102 of FIG. 1 and a detailed description is omitted here for brevity.

At step 603, the decoder performs inter prediction of a plurality of blocks of a first picture based on a plurality of reference blocks from the one or more reference pictures. Specifically, the decoder 80 performs a prediction operation using the reference pictures to obtain a plurality of prediction blocks of the first picture. In more detail, the decoder 80 performs inter-prediction using the reference pictures as reference pictures, to obtain the prediction blocks.

In this embodiment, the one or more reference pictures are at a lower resolution than the first picture. This is because, for example, the plurality of reference pictures may represent previous pictures (or “frames”) which have been encoded into a bitstream at a lower resolution than the corresponding original pictures from the original video data (i.e. they may be the pictures that are decoded at the decoder based on an encoded bitstream), for example to account for network conditions at the time of said encoding. These previous pictures may be stored in the decoder and encoder as a reference frame set in order to be used for inter prediction of future pictures. As such, each reference picture corresponds to an original picture form original video data (though there are differences due to the lower resolution

and possible prediction errors in obtaining the reference pictures).

As such, the inter prediction operation of step 604 involves upsampling the reference blocks of the reference pictures (or the entire reference pictures) in order to predict the blocks of the first picture.

At step 604, the decoder 80 obtaining a weighted filter to be applied to the plurality of inter predicted blocks of the first picture to reduce an error between the first picture and a corresponding original first picture, based on the coding information, by determining a weighting map using a weighting map function, the weighting map comprising a plurality of weights mapped to respective spatial locations in each of the inter predicted blocks of the first picture, wherein the inter predicted blocks of the first picture are used as an input to the weighing map function, and determining a filter to be applied to the inter predicted blocks of the first picture with the weighting map, wherein the filter is configured to be applied, with the weighting map, to the inter predicted blocks of the first picture to obtain a filtered first picture, such that the filter is applied with different weights to different spatial locations in each of the inter predicted blocks of the first picture.

Here, the decoder 80 determines a weighting map using the weighting map information. In this embodiment, the decoder 80 determines a weighting map using the weighting map information. In this embodiment, the weighting map information comprises a weighting map function to be used to calculate the weighting map.

One such example is that, when a sharpening filter is to be used, the weighting map information comprised in the coding information is a local gradient calculation function. In such an example, at step 103, the decoder 80 applies the gradient calculation function to calculate the gradient at each location in the inter-predicted blocks of the first picture, thereby arriving at a scalar weighting map having a same resolution as that of the first picture (with a value corresponding to each respect location in the picture). In other words, the first picture is provided as an input to the weighting map function.

However, it will be appreciated that this is just one example. In other embodiments, the weighting map may have a different resolution to the first picture and/or may comprise vector values rather than scalar values. Furthermore, it will be appreciated that the example of a picture gradient function is just an example, and that in practical implementations of embodiments, the choice of appropriate weighting map function will depend on the circumstances, particularly which filter is to be used. These factors and possible variants will be discussed in more detail later.

Furthermore, while it has been discussed in this embodiment that the coding information comprises weighting map information which comprises a weighting map function, embodiments are not limited in this respect. For example, in some embodiments a plurality of weighting map functions are stored at the decoder 80. In such cases, the weighting map information instead comprises an indication of which weighting map to use. Moreover, in some embodiments, the coding information does not comprise any explicit weighting map indication. Instead, for example, the coding information may comprise filter information, with the decoder 80 then inferring the weighting map function to be used (e.g. if the coding information indicates that a sharpening filter should be used, the decoder infers that a picture gradient function should be used as the weighting map function). These factors and possible variants will be discussed in more detail later.

At step 604, the decoder 80 further determines a filter to be used. In this embodiment, the decoder 80 infers the filter to be used from the weighting map information. As discussed above, in one example, the weighting map information comprised in the coding information is a local gradient calculation function. In this example, the decoder 80 can infer that a (e.g. pre-stored) sharpening filter should be used in conjunction with the weighting map that comprises picture gradients.

At step 606, the decoder 80 applies the weighting map and filter to the inter-predicted blocks of the first picture to obtain a filtered picture. Hence, step 606 involves using the determined weighting map so that the filter is applied with different strengths to different regions of the inter-predicted blocks of the first picture.

In this embodiment, applying the weighting map and filter to the first picture involves providing both the first picture and weighting map as inputs to the filter. This results in the filter being applied with different strengths to each value of the picture, depending on the value of the respective weight in the weighting map. The output of the filter is a map of offset values. The map of offset values in this embodiment corresponds in resolution to the first picture. Once the map of offset values is output, the offset values are then added to the values of the first picture to result in an output (enhanced) picture.

In the above discussion, it is assumed that the filter is a sharpening filter configured to sharpen blurred edges. However, embodiments are not limited to this, and any suitable filter for enhancing the picture can be used instead.

Following step 605, the output picture can then be used for any desired purpose. In one example, the decoder 80 then displays the output picture to a viewer. In another example, the decoder 80 stores the picture for later use. In another example, the decoder 80 transmits the picture to an external device for display.

In this embodiment, the weighted filter may be added to a reference set for future filter optimizations.

A complementary method can be performed by the encoder 90 in order to encode the bitstream provided to the decoder 80. FIG. 7 shows a flowchart of the operations of the encoder 90 according to this embodiment.

At step 701, the encoder 90 obtains original video data. For example, the encoder 90 may receive the original video data through a communication network (e.g. the internet) from an external server. However, there is no limit in the embodiments as to how the original video data is obtained.

At step 702, the encoder 90 performs performing a trial encoding of at least a part of the original video data into trial encoded video data. For example, this trial encoding may involve encoding inter prediction parameters for obtaining a trial first picture from reference pictures. The at least a part of the original video data may refer to a picture (or “frame”) or a slice, for example.

At step 703, the encoder 90 obtains a trial first picture based on the trial encoded video data. In this embodiment, this step involves performing inter prediction of a plurality of blocks of the trial first picture based on a plurality of reference blocks from the one or more reference pictures, the one or more reference pictures being at a lower resolution than the trial first picture. As such, this step involves upsampling at least the referenced reference blocks from the one or more reference pictures.

At step 704, obtains a weighted filter to be applied to the plurality of inter predicted blocks of the trial first picture to reduce an error between the trial first picture and a corresponding original first picture in the original video data, by determining a weighting map using a weighting map function, the weighting map comprising a plurality of weights mapped to respective spatial locations in each of the inter predicted blocks of the trial first picture, wherein the inter predicted blocks of the trial first picture are used as an input to the weighing map function, and determining a filter to be applied to the inter predicted blocks of the trial first picture with the weighting map, wherein the filter is configured to be applied, with the weighting map, to the inter predicted blocks of the trial first picture to obtain a filtered first picture, such that the filter is applied with different weights to different spatial locations in each of the inter predicted blocks of the trial first picture.

In performing these steps, the encoder 90 determines a combination of weighting map and filter to be used to enhance the trial first picture by applying the filter with different weights to different regions of the inter predicted blocks of the first picture.

In order to determine a combination of weighting map and filter that enhances the picture, step 704 may involve a rate distortion (RD) optimization process involving iteratively applying a plurality of filters with a plurality of weighting maps to the trial first picture. For each application, an average difference in values between the resulting picture and a corresponding picture from the original video data is determined. This cycle continues until a stopping criterion is met (e.g. an optimum weighting map has been determined for a particular filter).

In other words, an RD-optimization process takes place at the encoder, based on estimated signaling rate and distortion of the obtained picture.

A first example of a suitable stopping criterion is that a particular weighting map results in an average absolute difference (or average squared difference) of values between the resulting picture and a corresponding picture from the original video data being less than a predetermined threshold difference. A second example of a suitable stopping criterion is that an average absolute difference (or average squared difference) of values between a weighting map of the current iteration of the iterative process and a weighting map of the previous iteration of the iterative process is less than a second predetermined threshold difference. The first example of a suitable stopping criterion directly measures the output quality and therefore can be assumed to result in higher ultimate picture quality than the second example. However, the second example ensures that the iterative process does not require excessive computation time. In some embodiments, both of these examples are used, and the iterative process stops when either one of these two stopping criteria is met.

In the example discussed above with regard to FIG. 6, a single (sharpening) filter is used (with a corresponding weighting map). However, while this embodiment has been discussed with regard to finding a single combination of filter and weighting map, embodiments are not limited in this respect. For example, in some embodiments, the encoder may identify a plurality of combinations of weighting map and different types of filter to be used.

The method of FIG. 7 then continues to step 705, in which the encoder 90 encodes the video data and coding information into a bitstream, the coding information comprising the weighting map information.

Through the methods discussed with reference to FIGS. 6 and 7, it can be seen that there is an in-loop filtering method which is applied inside the encoding loop of a video compression system. The in-loop weighted filter employs a function for calculating a local weighting/parameter map and a filtering function. The weighting map function makes use of the input picture and optionally coding information/signaled parameters to calculate the weighting map. The filtering function makes use of the input picture, weighting/parameter map, and optionally coding information/signaled parameters to calculate the filtered picture.

According to this method, by applying a filter with local weightings, it is possible to increase coding performance and allow for a wider range of applications. Through the use of a weighting function to determine a weighting map, a weighted filtering can be used with weights to guide the properties of a filter at each spatial location. For example, the strength of a sharpening filter can be increased at locations of a picture which are close to edges and decreased at regions which are further away from edges. With that, ringing artifacts and overshoot might be reduced while maintaining sharpening properties.

In some examples, the optimisation discussed with reference to steps 704 FIG. 7 involves iterating between filter and weighting map function parameters. For example, starting parameters for a weighting map are set, and then the filter parameters are optimised based on the current weighting map. Then the weighting map parameters are optimised based on the found filter parameters and so on. In such cases, the coding information would comprise information on the weighting map function as well as the filter function (e.g. the parameters to be used). Of course, this is a basic form of optimization procedure. In some cases, additional side constraint can be set, for example in order to not only determine the best filter and weighting map in terms of picture quality but also to have the coding rate as low as possible. This can be achieved by introducing those conditions in both of those individual optimizations and selecting the starting point for the next iteration under consideration of rate costs as well. More generally, it is possible to additionally introduce simplifications that limit the computational costs.

In this embodiment, the weighting map provides linear weightings for the filter. However, embodiments are not limited to this, and in other embodiments, the values of the weighting map can instead modify the filtering procedure itself. For example, the filter could be parametric. For example, the frequency response of an edge enhancement filter could be dependent on the local weighting map parameter. For example, the sigma value in unsharp masking (one type of sharpening filter) could be dependent on the weighting parameter. That means that the way that the filter works or more specifically, the function of the filter is parametric and not necessarily linearly dependent of the weighting map. Another example is a filter that does an edge thinning (sharpening) by warping the picture. The strength of the warping could depend on the current weighting map value.

In this embodiment, the weighted filter may be added to a reference set for future filter optimizations.

In this embodiment, the weighted filter is applied in-loop. However, embodiments are not limited to this particular order, and a weighted filter may be applied at other processing steps additionally or alternatively in other embodiments, such as post-loop.

In a variant of this embodiment, prior to step 705 of FIG. 7, the encoder 90 makes a determination as to whether or not to include any information regarding the weighted filter in the coding information (i.e. whether or not the decoder should obtain and apply a weighted filter). In particular, as already discussed above, steps 701-704 involve a trial encoding of a picture (or slice) to find the motion vectors of the inter-prediction. This is used to find the low-resolution blocks which are referenced by the current picture. Given this information, a filter is optimized such that the error between the referenced blocks and the ground truth of the current (high-resolution) picture is minimized.

In this variant, a next optimization round takes place after step 704, in which the filter is used to enhance all low-resolution blocks (of the reference pictures) in the motion compensation optimization such that optimized motion vectors considering the filtered low-resolution pictures can be found. Then, it is determined that the weighted filter should be used at the decoder end if the RD-performance is superior to the unfiltered version (i.e. a version in which the weighted filter is knot use.

In summary, in this variant, the following set of steps takes place:
1. Trial encode a picture (or slice)
2. Find prediction data (from low-resolution reference pictures) and their corresponding ground-truth in the first (current) picture
3. Optimize a weighted filter such that the error of the prediction is minimized
4. Encode the picture (or slice) with the weighted filter
5. If the RD-performance of step 4 is better than step 1: take the result of step 4 and add the filter to the reference set for future filter optimizations. Otherwise use the output of step 1.

As discussed, this second embodiment may involve optimizing the filter based on a set of (potentially transformed, e.g. shifted) blocks such that the error between those blocks and the ground truth of the current picture is minimized. Thereby, the set of blocks and their prediction signal may be derived by a trial encoding of the picture or slice (or by a pre-analysis of the picture content). Based on the, potentially estimated, signal in the picture (i.e. current frame) a filter or set of filters is optimized by minimizing the errors between the prediction signals and the ground truth of the current blocks.

In some embodiments, this method is applied iteratively since the prediction signal changes which might lead to a different set of blocks being chosen by the pre-estimation method.

It will further be appreciated that the first and second embodiments discussed above can be combined by applying a joint optimization. Thereby the weighted filter can be optimized such that it minimizes a weighted sum of loss terms which are combined of losses of error terms generated by the method of the first embodiment or the method of the second embodiment.

In some embodiments, the weighting map function is an edge detector which assigns higher weights to locations which are on an edge and lower values around edges and in flat regions. Hence, in such embodiments, the resulting weighting map is a scalar. With that, an edge sharpening with less artifacts could be achieved. In such embodiments, the encoder could encode information identifying the edge detector function in the bitstream, for example.

In other embodiments, the weighting map function is a detector for ringing artifacts. This would, for example, assign a probability that there is ringing at a given location. Hence, in such embodiments, the resulting weighting map is a scalar. Through application of this weighting map, the filter strength would then be set based on this probability. In such embodiments, the filter could, for example, be a simple linear low-pass filter. However, in many cases, ringing is close to edges which should, ideally, be preserved. Therefore, the filtering solution should, ideally, preserve edges. One example for a filter that is suitable for that would be a bilateral filter. Parameters could be optimized at the encoder and transmitted in the bitstream in embodiments making use of such filters.

Furthermore, in some embodiments, these two options of weighting maps can be combined into a two-dimensional weighting map or they can both be applied sequentially. Combining them gives more flexibility with regards to the filtering. Knowing about the estimated probability of ringing and the presence of edges helps the encoder to find the optimal filtering in its rate distortion optimisation process. For example, an edge amplification should be applied more carefully, if ringing is very close to this position as this may be amplified, which can be optimised by the encoder in the encoding process.

The example of applying a bilateral filter also shows an example of how a multi-dimensional weighting map could be applied in some embodiments, rather than just a scalar). For example, in some embodiments, the encoder determines different parameters if there is a large contrast area compared to areas with small contrast. In this case, the parameters of the bilateral filter are estimated from the obtained picture and signaled to the decoder.

Another application in other embodiments is to estimate parameters of the edge sharpening filter from the picture. For example, if the weighting map estimates whether there is very sharp content like text at a certain location in the picture/block, a different sharpening can be applied compared to other types of content. Note that in such embodiments, the weighting map can be derived from the picture content, coding information or signaled parameters. In these embodiments, the weighting map can be one-dimensional. The weighting map can be binary, integer or floating-point. In these embodiments, the weighting map may alternatively be multi-dimensional, with each element being binary, integer or floating-point. The data type of each element of the weighting map depends on the requirements of the filtering system.

In some embodiments, the weighting map calculation parameters are signaled in the bitstream and decide on the type of weighting map function. In other embodiments, the signaled weighting map calculation parameters are parameters to the function itself. For example, an edge map could have a steepness scaling parameter which decides how much the weighting is increased based on the steepness. Note that this might be a non-linear scaling. For example, a scaling by taking the n-th power of the value could be used.

In some embodiments, a set of, (possibly parametric) weighting map functions are pre-defined. As such, the bitstream signals only the used weighting map function(s)/weighting map(s) (and possibly particular parameters to be used in these weighting map functions) rather than the entire weighting map function.

In summary regarding the weighting map, in some embodiments, a weighting map function is applied which outputs a scalar weighting map, with the scalar being binary, integer or floating-point. In other embodiments, a weighting map function is applied which outputs a multi-dimensional weighting map, with each element being binary, integer or floating-point. In these embodiments, the weighting map information for one or more channels of the obtained picture is computed while using the information from one or more channels of the reconstructed picture as input. In some embodiments, a set of, (possibly parametric) weighting map functions are pre-defined, with the bitstream signalling the used weighting map function(s)/weighting map(s).

Regarding the filter, the filter function(s) used in some embodiments of the invention is generally a multi-dimensional parametric function which takes the weighting map, filter parameters, one or more channels of the obtained picture and possibly coding information as input. The output is one or more (weighted) filtered channels of the obtained picture.

While the embodiments have generally been discussed with regard to the application of a single filter, the invention is not limited in this respect. For example, in other embodiments, a series of filters with different parameters and potentially different weighting maps may be applied. Depending on the type of artifacts, complexity requirements and RD-decision, different filtering functions may be most suitable.

For example, in some embodiments, a linear weighted filter may be used. In such embodiments, this filter can be weighted by multiplying the output of the filter by the local weighting and then adding the result to the obtained picture. The advantage of such a system would be that the optimal parameters could be found by a least-squares optimization. Consequently, there is no parameter search required to find the optimal solution.

However, in such embodiments, the linear filter would require, depending on the characteristics of the picture, a relatively large number of filter coefficients (which would need to be transmitted). To counteract that, in some embodiments, a parametric description of the filter is used to decrease the coding costs (though this is at the cost of reduced flexibility).

An example of a parametric description is to model a high-pass filter as Difference of Gaussian filter. Then, only the sigma values need to be transmitted instead of the whole set of filter coefficients. This approach is useful if the frequency response of the parametric filter is close enough to the distribution of filters which would be obtained by least squares optimization. However, depending on the side constraints of the parametric representation, a closed form solution might not be found, in which case an iterative optimization would be required.

Another type of filter that can be used in another embodiments is a (parametric) non-linear filter. Examples include bilateral filters, median filters, or other filters. The parameters of those filters can be signaled in the bitstream or given by the weighting map. Note that switching the type of filtering function based on weighting map parameters is also an option.

In other words, in some embodiments, the value of the weighting map at a particular scalar location can indicate the type of filtering function to be used at that spatial location of the picture.

In summary regarding the filter, in some embodiments, one or more filters can be applied for each signaled weighting map. The filtering function and the parameters of the filter may be signaled in the bitstream, pre-defined or inferred from the content of the video sequence or coding information. In some embodiments, a linear filter is applied as the filter in the filtering function. The shape of the filter may be indicated in the bitstream or pre-defined. In some embodiments, the linear filter is optimized by a least-squares optimization or RD-optimized. In some embodiments, a parametric linear filter is used, where the parameters can be used to generate the corresponding linear filter. In some embodiments, the parametric linear filter is RD-optimized with regards to a minimal error at the output or RD-optimized. The optimum filter may be derived by least squares optimization, iterative search, or exhaustive search. In some embodiments, a parametric or non-parametric non-linear filter is applied in the filtering function. In some embodiments, a bilateral filter in the filtering function. In some embodiments, a combination of the discussed filtering methods is applied, where the used filtering method at each location is signaled or indicated by the weighting map. In some embodiments, the encoder optimizes a parametric weighting map together with the filtering function.

In some of the embodiments described herein, the weighted filter has been described as being applied to a whole picture (e.g. a whole reference picture). However, embodiments are not limited in this respect. In variants of these embodiments, there may be different filtering setups for different partitions of a picture. Furthermore, an overlapping application of filters is possible. Two example implementations for region partitioning will now be discussed.

The first is a block-wise partitioning of the picture, with each filter being applied to one or more blocks. An alignment to coding tree unit (CTU) and coding (CU) boundaries may be considered in some embodiments. The applicable picture partitioning would then be signaled in the bitstream.

The second is to partition the picture based on picture characteristics. In some embodiments this partitioning can derived at the decoder side as well as on the encoder side without the need for signaling in the bitstream. This could be implemented as a binarized or non-binary weighting map. Each resulting partition can then be handled individually, or partitions are handled in groups in embodiments.

When region partitioning is used, the filters to be applied to one partition or partition group can be optimized at the encoder side and the parameters can then be signaled in the bitstream.

Hence, in some embodiments, a picture can be split into multiple partitions. The partitions may be defined by a signaled block-partitioning, signaled region partitioning criteria and/or by a binarized weighting map function. Furthermore, in some embodiments, multiple filters can be applied to the same picture partition.

The use of partitions in these ways can be useful particularly when dealing with larger or very diverse pictures. For such pictures, very different types of content might be present, and the error characteristics might be very different at different partitions of the picture. Consequently, optimizing two or more filters for different partitions of the picture might lead to superior performance.

As discussed in the described embodiments, coding information can be included in the bitstream, for example regarding the weighting map function and/or filter to be applied. More generally, in embodiments, the coding information can comprise (but is not restricted to) filter coefficients, weighting map function parameters, on-/off-flags, filter encoding parameters or region parameters etc.

In some embodiments, this information (e.g. all the parameters) is encoded and signaled so as to reduce the transmission rate and increase the efficiency of the overall filtering process. This is done by exploiting redundancies with regards to the transmitted parameters. Those redundancies are exploited by prediction and entropy coding on filter parameters. Moreover, in some embodiments, parameters are quantized to reduce the number of possible representations. A detailed description of a parameter coding scheme which can be used for encoding parameters of this type of filter can be found inPCT/CN2023/105596, which is hereby incorporated by reference in its entirety.

In the embodiments described herein, the filter that is used (i.e. the sharpening filter) is based on the concept of a Wiener filter. In other embodiments, the filter is a linear filter that has been optimized at the encoder by a least-squares optimization procedure (i.e. a linear filter that minimizes the squared error between the filtered signal and the ground-truth signal). Of course, in some embodiments, additional side constraints are set in the determination of the signal enhancement filter, such as the filter shape, and filter coefficients that have to be equal.

However, while the embodiments have been discussed with reference to a filter based on the concept of a Wiener filter, embodiments are not limited in this respect, and other types of filter could be used instead, such as a filter based on a Sobel-filter or unsharp masking filter as sharpening filters. Other non-linear options include bilateral filters and diffusion filters, as well as an Adaptive Loop Filter (ALF).

For example, in some embodiments, the weighted filter can be integrated into the adaptive loop filter (ALF) of existing coding schemes (e.g. H.265/HEVC and H.266/VVC) and applied to partitions derived by the ALF optimization as an alternative to linear filters.

Given the similarities between the determination of the weighted filter in the first and second embodiments (e.g. step 204 of FIG. 2 and step 704) the specific implementation details and variations described with respect to the first embodiments are not repeated herein for brevity. However, it will be appreciated that they are applicable to this second embodiment.

As an overview of this method of the second embodiment, let there be a video sequence which is encoded with RPR. The sequence will be encoded at high resolution for a certain number of pictures, then switch to a lower coding resolution and then switch to a higher resolution again. Having one filter for each low-resolution picture be RD-optimized and applied for the inter-predicted blocks from this picture is not necessarily efficient since it is not the case that the whole picture needs to be upscaled and refined since the filter is also used to improve the upscaled low-resolution output pictures. First, not all low-resolution pictures may be used as reference for high-resolution pictures. Moreover, not all picture areas may be used as reference. This first embodiment optimizes the filter for the blocks which are estimated to be used by the high-resolution frame. To find the referenced blocks, a trial encoding of the slice may be done. Then, all referenced low-resolution blocks are stored alongside with the ground truth data of the motion compensated block in the current picture. If the referenced low-resolution area is lower than a predefined threshold, the optimization could be skipped. Otherwise, the filter may be optimized such that the error summed over all blocks is least-squares minimized. Next, the filter may be assigned to the high-resolution picture and the picture is encoded again. If the RD-costs of encoding the picture with the filter are lower than without, the filter may be set. Otherwise, the picture may be encoded without the filter.

As an example, an optimisation algorithm may be summarised as follows:
1. Encode the slice (or block or picture)
2. Test whether the references are from low-resolution pictures in at least 2% of the picture area
   a. If true: Proceed with step 3
   b. If false: Proceed with step 7
3. RD-optimize the enhancement based on the inter-predicted blocks and their corresponding ground-truths
4. Assign the filter as enhancement filter to the current slice (or picture or block) and trial encode the slice (or picture or block)
5. Test whether the RD-performance with the filter is better than without the filter
   a. If true: Proceed with step 7
   b. If false: Proceed with step 6
6. Remove the assigned filter and re-encode the slice without the filter
7. End of slice compression

In summary, in some arrangements, picture upscaling in RPR can be done by multi-phase interpolation filters. The upscaling is used for inter-prediction and to rescale the picture before it is written to the output stream. In these embodiments, this is modified such that a weighted edge enhancement filter is applied in the inter-prediction process or such that the edge enhancement filter is applied in the inter-prediction and to upscale the low-resolution pictures after upscaling.

As discussed, the first embodiment and second embodiment provide a weighted edge enhancement filtering method in the context of reference picture resampling. The methods can be applied as enhancement filters for inter-predicted blocks of low-resolution pictures and in a scenario where the same filter is applied as enhancement filter for inter-predicted blocks of low-resolution pictures and as an enhancement filter for upscaled low-resolution pictures before their output.

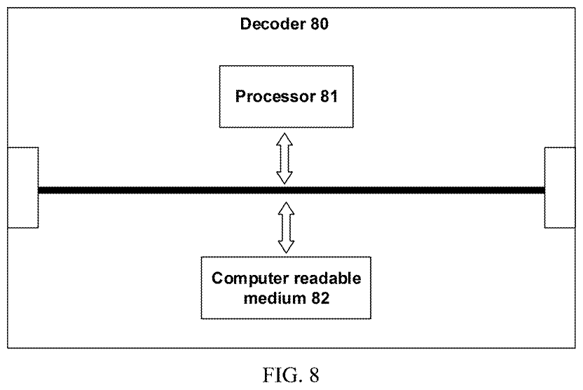

FIG. 8 shows a schematic illustration of a decoder 80 according to an embodiment. Specifically, FIG. 8 shows a schematic illustration of a decoder 80 configured to perform any of the decoder methods discussed herein. Such detailed descriptions thereof are omitted here for brevity.

As shown in FIG. 8, the decoder 80 comprises a processor 81 and a computer readable medium 82. The processor 81 and the computer readable medium 82 may be connected via a bus system. The computer readable medium is configured to store programs, instructions or codes. The processor 81 is configured to execute the programs, the instructions or the codes in the computer readable medium 82 so as to complete the operations in the decoder method embodiments herein.

Hence, in embodiments, the computer readable medium 82 is configured to store a computer program capable of being run in the processor 81, and the processor 81 is configured to run the computer program to perform steps in any of the decoder methods discussed herein.

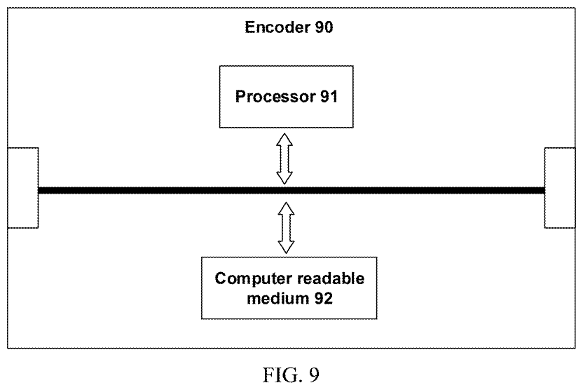

FIG. 9 shows a schematic illustration of an encoder 90 according to an embodiment. Specifically, FIG. 9 shows a schematic illustration of an encoder 90 configured to perform any of the encoder methods discussed herein. Such detailed descriptions thereof are omitted here for brevity.

As shown in FIG. 9, the encoder 90 comprises a processor 91 and a computer readable medium 92. The processor 91 and the computer readable medium 92 may be connected via a bus system. The computer readable medium is configured to store programs, instructions or codes. The processor 91 is configured to execute the programs, the instructions or the codes in the computer readable medium 92 so as to complete the operations in the decoder method embodiments herein.

Hence, in embodiments, the computer readable medium 92 is configured to store a computer program capable of being run in the processor 91, and the processor 91 is configured to run the computer program to perform steps in any of the decoder methods discussed herein.

As discussed, in embodiments, the weighted filter is a parametric filter. Depending on the implementation it is also content-adaptive in some embodiments. The two main objectives of the filters discussed in the embodiments are the sharpening of blurred content and the reduction of ringing artifacts. However, other objectives for the filtering process are possible, such as to reduce blocking artifacts.

In some embodiments, the weighted filter is a local adaptive filter. Therefore, it can be used to deal with non-linear filtering problems. Two useful applications would be the reduction of ringing artifacts and the sharpening of edges. Those two problems can be hard to address with linear filters. The weighted filter of embodiments of the invention employs a straightforward concept to overcome the limitations of conventional linear filters. The idea is to apply two filters. The first extracts local information from the decoded picture. The second filter applies a filtering which depends on the output of the first filtering setup. In some embodiments, the second filter is RD-optimized depending on the output of the first filter. With that, non-linear filters that are adaptive to certain picture features can be signaled.

In order to put the features of embodiments of the invention into further context, a discussion will now be provided regarding the weighted filtering of these embodiments relative to existing in-loop filters.

In-loop filtering is part of modern video coding systems. Usually, a set of different filters is applied sequentially. Those filters may be parametric, i.e. a set of filter parameters is sent that change the behavior depending on RD-decisions. They may also be non-parametric. Moreover, the filter may be content adaptive (i.e. the filter can have a different behavior depending on the spatial location in the picture). Sample adaptive offset (SAO) filters and adaptive loop filters (ALF) perform local classification of the content and apply different operations depending on the class. Usually, the classification operation to be applied is signaled.

In detail, the in-loop ALF method optimizes a set of linear filters. Each linear filter is applied to a partition of the picture. The partitioning is derived by local properties of the picture. Moreover, partitions might be merged. Such information is signaled in the bitstream. In embodiments of the invention, however, a locally weighted/parametrized filter is applied. As such, the need for picture partitioning and the optimization of multiple filters is reduced, thereby increasing coding efficiency.

In SAO, each sample (or ‘pixel’) is assigned to one class depending on local characteristics of the picture. For each class, an (intensity) offset is computed and signaled at the encoder. Hence, a class decision is done and for each class, a different operation is done. In embodiments of the invention, however, a locally weighted/parametrized filter is applied. As such, the need for picture partitioning and the optimization of multiple filters is reduced, thereby increasing coding efficiency.

As discussed, embodiments provide methods and devices to code parameters for an in-loop (or post-loop) filtering scheme. Thereby, the demands of a transmission in an adaption parameter set and the characteristics of coding information can be considered to allow for an efficient encoding. Embodiments employ a weighted/parametric filtering. The weighting/local parameters are calculated from a decoded video picture (e.g. a picture block). In some embodiments, the calculation functions may be parametric and/or signaled by the encoder.

In the following, we call the local parametrized weights the “weighting-map”.

While the term “weighting map” has been used, this term is used for readability purposes and is not meant in a restrictive way. For example, in some embodiments the weighting map might contain local parameters or a vector containing parameters and weighting values at the same time. In addition to the calculation of the weighting, a filter is applied. In some embodiment, this filter may be parametric with regards to the weighting map, or it may be locally weighted according to the weighting map.

As discussed, embodiments relate to optimization methods for weighted filters, such as weighted edge enhancement filters. The methods may also be used for the optimization other types of filters which aim at the enhancement of reference pictures.

The optimization methods can be used for the optimization of weighted filters for the application as in-loop filters. These optimization techniques provide advantages over optimizing a separate filter for each low-resolution picture if the filter is only applied as an in-loop filter for the enhancement of inter-predicted blocks originating from low-resolution pictures. The first application would make sense in a reference picture resampling/adaptive resolution coding scenario where the filter is applied to increase the quality of the low-resolution pictures before they are shown to the viewer and the reference pictures. However, the post-filtering of upscaled pictures might not be desired in some applications where the upscaling operation is defined by the viewer depending on their needs. i.e. it is not always desired in all applications to apply both.

The optimization target changes if the upscaling post-filtering is not being applied. Therefore, the optimization procedure and the filters optimized in this way would be different. Moreover, it makes sense to assign the optimized filter to a high-resolution picture in a coded video sequence and not to the low-resolution pictures. Usually, there are some pictures coded at high-resolution. Then, the resolution is changed to a lower coding resolution base on bandwidth and/or content. At some point, the resolution may be switched again to a high resolution. At this point there is the option that low-resolution pictures are referenced by a high-resolution picture.

In this case, an enhancement of referenced low-resolution blocks may be used. In such a scenario, the first high-resolution references areas of the low-resolution pictures. However, not all reference pictures in the reference set may be used as reference and not all parts of the reference picture may be used in the prediction. Therefore, it is proposed to optimize a filter for a high-resolution picture such that it can be applied reasonably well for all the content which may/is expected to be referenced by the high-resolution picture. The motivation for using this optimization and filter assignment scheme is to have a more efficient filter encoding. Generally, it is not efficient to optimize a separate filter for each low-resolution pictures since not all pictures are used by the inter-prediction and even if they are, there are sometimes only small parts of the picture referenced. In such a scenario, it is too costly to optimize a separate filter. In the given scenario, the filters are used to enhance blocks from low-resolution pictures if they are referenced by high-resolution pictures. Usually, the different pictures are referenced more or less frequently depending on the motion in the video sequence, the temporal distance and other factors. Moreover, not all regions of a picture are referenced with equal probability. Consequently, it makes sense to optimize a filter in a way such that those statistical biases are taken into account. Methods for doing so are proposed have been proposed herein.

In particular, described embodiments provides a method to estimate filter parameters for an in-loop filtering scheme, including to derive filter coefficients based on a set of, potentially overlapping, blocks or partitions. The blocks may originate from the current picture and/or a set of temporally spaced pictures. The filter may be applied to the result of the interpretation of subblocks or to enhance a partition of an assigned picture. The described embodiments involve optimizing the filter for the application as in-loop filter (i.e. the output of the filter may be re-used by the prediction system to encode subsequent pictures).

The described weighted filters are applied to the inter-prediction to enhance the output of the inter-prediction based on criteria like coding information or any results of the pre-analysis. These criteria may be derived from the video content or signaled in the bitstream. Moreover, the weighted filter can also be applied to the whole set of reference frames to generate enhanced references. Besides rounding issues, this would result in equivalent results.

As discussed, embodiments provide an in-loop filtering method which can be applied inside the encoding loop of a video compression system. The in-loop filter employs a function for calculating a local parameter map and a filtering function. The weighting map function may use input pictures/blocks, coding information and/or signaled parameters to calculate the weighting map. The filtering function may use input pictures/blocks, coding information, signaled parameters and/or the parameter map to calculate the filtered picture. The optimization may be done based on potentially overlapping blocks or partitions of pictures. The optimization may use the ground truth and prediction signals of the current and all reference pictures to find an optimized filter for the enhancement of encoded signals.

In some embodiments, the weighted filter is optimised based on a set of reference pictures and their ground-truth representation. Thereby, the error between the reference pictures and their corresponding ground-truth representation is minimized by doing a weighted joint optimization such that one or multiple filters are optimized such that applying those filters to the set of reference pictures minimizes the weighted error.

In some embodiments, the error of the reference frames is weighted based on their temporal distance to the current frame.

In some embodiments, the error of the reference frames is weighted based on local image features or knowledge from encoding this or other frames of the video.

In some embodiments, the picture is optimised based on the prediction signal and the error to the ground truth of the current picture.

In some embodiments, the prediction signals are derived by a trial encoding of the picture or slice.

In some embodiments, the prediction signals are derived by a pre-analysis of the reference picture, current picture, their corresponding ground truth signals and coding information.

In some embodiments, a pre-analysis or trial encoding and a filter optimization step are iteratively performed until some stopping criterion is met.

In some embodiments, a weighted loss of the filtering of blocks in reference frames and prediction signals are jointly optimized.

In some embodiments, the method is integrated into a coding loop as an additional processing step, as alternative to an already existing loop filter or integrated into an already existing loop filter.

In some embodiments, the method is RD-optimized based on estimated signaling rate and distortion after applying the method.

In some embodiments, the method is applied to the luma-channel, the chroma channel or both. The processed channels may be set in advance, signaled in the bitstream or inferred from the content.

While some embodiments have been described as being applied to a picture, embodiments are not limited in this respect. For example, in some embodiments, the method is applied to one or multiple partitions of a picture. The partitions may be defined by a signaled block-partitioning, potentially signaled region partitioning criteria or by a binarized weighting map function.

In some embodiments, multiple filters are applied to the same picture partition.

In some embodiments, the method is used to address the problem of ringing artifacts, blurring or blocking artifacts.

In some embodiments, the method involves applying a weighting map function which outputs a scalar weighting map, with the scalar being binary, integer or floating-point.

In some embodiments, the method involves applying a weighting map function which outputs an n-dimensional weighting map, with each element being binary, integer or floating-point.

In some embodiments, the weighting map information is computed for one or more channels of the reconstructed picture while using the information from one or more channels of the reconstructed picture as input.

In some embodiments set of, possibly parametric weighting map functions are predefined, and the encoder signals the used weighting maps and weighting map functions.

In some embodiments, one or more filters are applied for each signaled weighting map. The filtering function and the parameters of the filter may be signaled in the bitstream, pre-defined or inferred from the content of the video sequence or coding information.

In some embodiments, the method involves applying a linear filter as the filter in the filtering function. The shape of the filter may be indicated in the bitstream or pre-defined.

In some embodiments, the linear filter is optimized by a least-squares optimization or RD-optimized.

In some embodiments, a parametric linear filter is applied. The parameters can be used to generate the corresponding linear filter.

In some embodiments, the parametric linear filter is RD-optimized with regards to a minimal error at the output or RD-optimized. The optimum filter may be derived by least squares optimization, iterative search, or exhaustive search.

In some embodiments, a parametric or non-parametric non-linear filter is applied in the filtering function.

In some embodiments, a bilateral filter is applied in the filtering function.

In some embodiments, a combination of the described filtering methods are applied, where the used filtering method at each location is signaled or indicated by the weighting map.

In some embodiments, the encoder optimizes a parametric weighting map together with the filtering function.

In some embodiments, one or more filters are applied to partitions of the picture based on a signaled block-partitioning.

In some embodiments, one or more filters are applied to partitions of the picture based on derived region partitioning criteria.

In some embodiments, the weighted filter is integrated the adaptive loop filter (ALF) and is applied to partitions derived by the ALF optimization as an alternative to linear filters.

In some embodiments, the encoder encodes the filter and weighting map calculation parameters by a quantization, prediction, or entropy coding scheme.

In some embodiments, the weighted filter is applied as a post-filter.

Embodiments of the invention can also provide a non-transitory computer-readable medium having computer-executable instructions to cause one or more processors of a computing device to carry out the method of any of the embodiments of the invention.

Examples of computer-readable media include both volatile and non-volatile media, removable and non-removable media, and include, but are not limited to: solid state memories; removable disks; hard disk drives; magnetic media; and optical disks. In general, the computer-readable media include any type of medium suitable for storing, encoding, or carrying a series of instructions executable by one or more computers to perform any one or more of the processes and features described herein.

It will be appreciated that the functionality of each of the components discussed can be combined in a number of ways other than those discussed in the foregoing description. For example, in some embodiments, the functionality of more than one of the discussed devices can be incorporated into a single device. In other embodiments, the functionality of at least one of the devices discussed can be split into a plurality of separate (or distributed) devices.

Conditional language such as “may”, is generally used to indicate that features/steps are used in a particular embodiment, but that alternative embodiments may include alternative features, or omit such features altogether.

Furthermore, the method steps are not limited to the particular sequences described, and it will be appreciated that these can be combined in any other appropriate sequences. In some embodiments, this may result in some method steps being performed in parallel. In addition, in some embodiments, particular method steps may also be omitted altogether.

While certain embodiments have been discussed, it will be appreciated that these are used to exemplify the overall teaching of the present invention, and that various modifications can be made without departing from the scope of the invention. The scope of the invention should be construed in accordance with the appended claims and any equivalents thereof.

Many further variations and modifications will suggest themselves to those versed in the art upon making reference to the foregoing illustrative embodiments, which are given by way of example only, and which are not intended to limit the scope of the invention, that being determined by the appended claims.

1. A method of processing video data, performed by an encoder, the method comprising:
obtaining a plurality of original pictures from original video data;
obtaining a plurality reference pictures, each corresponding to an original picture from the original video data, wherein the plurality of reference pictures are at lower resolutions than the original pictures from the original video data;
upsampling the plurality of reference pictures to obtain a plurality of upsampled reference pictures;
obtaining a weighted filter to reduce an overall error between the plurality of upsampled reference pictures and the corresponding original pictures, by:
determining a weighting map for each reference picture, using a weighting map function, the weighting map comprising a plurality of weights mapped to respective spatial locations of the upsampled reference pictures, wherein the upsampled reference pictures are used as an input to the weighing map function, and
determining a filter to be applied to the upsampled reference pictures with the respective weighting maps to obtain filtered upsampled reference pictures, such that the filter is applied with different weights to different spatial locations of the upsampled reference pictures;
performing inter prediction of a plurality of blocks of a first picture based on a plurality of reference blocks from one or more of the upsampled reference pictures; and
encoding coding information of the original video data into a bitstream, the coding information comprising information on the weighting map function and/or filter to be used at a decoder,
wherein the method further comprises:
applying the weighted filter to the plurality of upsampled reference pictures prior to performing the inter prediction, or
applying the weighted filter to upsampled referenced blocks of the reference pictures during the inter prediction.

2. A method of processing video data, performed by a decoder, the method comprising:
decoding a bitstream to obtain video data and coding information;
obtaining a plurality of reference pictures from the video data;
upsampling the plurality of reference pictures to obtain a plurality of upsampled reference pictures;
obtaining a weighted filter to reduce an overall error between the plurality of upsampled reference pictures and corresponding original pictures, by:
determining a weighting map for each reference picture using a weighting map function, the weighting map comprising a plurality of weights mapped to respective spatial locations of the upsampled reference pictures, wherein the upsampled reference pictures are used as an input to the weighing map function, and
determining a filter to be applied to the upsampled reference pictures with the respective weighting maps to obtain filtered upsampled reference pictures, such that the filter is applied with different weights to different spatial locations of the upsampled reference pictures; and
performing inter prediction of a plurality of blocks of a first picture based on a plurality of reference blocks from one or more of the upsampled reference pictures,
wherein the method further comprises:
applying the weighted filter to the plurality of upsampled reference pictures prior to performing the inter prediction, or
applying the weighted filter to upsampled referenced blocks of the reference pictures during the inter prediction.

3. The method of claim 2, further comprising adding the obtained weighted filter to a stored reference filter set.

4. The method of claim 2, wherein the coding information comprises signalled weighting map function parameters, and
wherein determining the weighting map using the weighting map function comprises:
applying the signalled weighting map function parameters as parameters of the weighting map function; and
providing the reference pictures or first picture as an input to the weighting map function.

5. The method of claim 3, wherein the coding information comprises signalled filter function parameters, and
wherein obtaining the filter comprises:
applying the signalled filter function parameters as parameters of the filter.

6. The method of claim 2, wherein applying the weighting map and the filter to the reference pictures or first picture to obtain the filtered reference pictures or first picture takes place within the coding loop or as a post-loop step; or
the step of applying the weighting map and the filter to the reference pictures or first picture to obtain the filtered picture is integrated into an adaptive loop filter and is applied to derived partitions.

7. The method of claim 2, wherein the reference pictures and/or picture comprise a luma-channel, a chroma channel or both, and
wherein the weighting map and the filter are applied to the luma-channel, the chroma channel or both;
which of the luma-channel and the chroma channel the weighting map and the filter are to be applied to is predetermined, signaled in the bitstream, or inferred from the picture's content.

8. The method of claim 2, further comprising partitioning in the reference pictures and first picture into a plurality of partitions,
wherein the weighting map and the filter are applied to one or multiple partitions of the reference pictures or first picture,
wherein the partitions are signaled in the coding information;
wherein the method further comprises applying multiple filters to a same picture partition.

9. The method of claim 8, wherein the partitions being signaled in the coding information comprises a signaled block-partitioning, signaled region partitioning criteria or a binarized weighting map function in the coding information.

10. The method of claim 2, wherein determining the weighting map using a weighting map function comprises:
applying a weighting map function which outputs a scalar weighting map, with the scalar being binary, integer or floating-point; or
determining the weighting map using a weighting map function comprises:
applying a weighting map function which outputs a multi-dimensional weighting map, with each element being binary, integer or floating-point.

11. The method of claim 2, wherein the weighting map information for one or more channels of the reference pictures is computed using information from one or more channels of the reference pictures as input.

12. The method of claim 2, wherein a set of weighting map functions are predefined, and
wherein the coding information signals the weighting map function to be used.

13. The method of claim 2, wherein the coding information signals a plurality of weighting map functions,
wherein determining the weighting map using the weighting map function comprises determining a plurality of weighting maps using the plurality of weighting map functions, and
wherein applying the weighting map and the filter comprises applying one or more filters for each signaled weighted map.

14. The method of claim 13, wherein the filtering function and parameters of the filter are signaled in the coding information, pre-defined, inferred from the content of the video, or inferred from the coding information.

15. The method of claim 2, wherein the filter is a linear filter, and a shape of the filter is indicated in the bitstream or predefined;
wherein the linear filter is optimized by a least-squares optimization or RD-optimized.

16. The method of claim 2, wherein the filter is a bilateral filter.

17. The method of claim 2, wherein determining the filter comprises determining a plurality of filters,
wherein applying the weighting map and the filter to the reference pictures or first picture comprises applying each filter of the plurality of filters at a location signaled in the bitstream or indicated in the weighting map.

18. The method of claim 2, wherein a parametric weighting map is optimised together with the filtering function.

19. The method of claim 2, wherein applying the weighting map and the filter to the reference pictures or first picture comprises applying one or more filters to partitions of the reference pictures or first picture based on a block-partitioning signaled in the coding information; or
wherein applying the weighting map and the filter to the reference pictures or first picture comprises applying one or more filters to partitions of the reference pictures or first picture based on derived region partitioning criteria.

20. A non-transitory computer-readable medium comprising computer executable instructions and a bitstream stored thereon, wherein the computer executable instructions, when executed by a computing device, cause the computing device to generate the bitstream by performing the following steps:
obtaining a plurality of original pictures from original video data;
obtaining a plurality reference pictures, each corresponding to an original picture from the original video data, wherein the plurality of reference pictures are at lower resolutions than the original pictures from the original video data;
upsampling the plurality of reference pictures to obtain a plurality of upsampled reference pictures;
obtaining a weighted filter to reduce an overall error between the plurality of upsampled reference pictures and the corresponding original pictures, by:
determining a weighting map for each reference picture, using a weighting map function, the weighting map comprising a plurality of weights mapped to respective spatial locations of the upsampled reference pictures, wherein the upsampled reference pictures are used as an input to the weighing map function, and
determining a filter to be applied to the upsampled reference pictures with the respective weighting maps to obtain filtered upsampled reference pictures, such that the filter is applied with different weights to different spatial locations of the upsampled reference pictures;
performing inter prediction of a plurality of blocks of a first picture based on a plurality of reference blocks from one or more of the upsampled reference pictures; and
encoding coding information of the original video data into a bitstream, the coding information comprising information on the weighting map function and/or filter to be used at a decoder,
applying the weighted filter to the plurality of upsampled reference pictures prior to performing the inter prediction, or
applying the weighted filter to upsampled referenced blocks of the reference pictures during the inter prediction.
